(19) United States
(12) Patent Application Publication
(10) Pub. No.: US 2026/0077333 A1
(43) Pub. Date: Mar. 19, 2026

(54) CARBONACEOUS MATERIALS FOR USE IN METHODS OF MANUFACTURING ACTIVATED CARBON

(71) Applicant: Arq IP Limited, London (GB)

(72) Inventors: Micala Mitchek, Denver, CO (US); Lingyan Song, Englewood, CO (US); Mowen Li, Highlands Ranch, CO (US); Joseph M. Wong, Castle Pines, CO (US)

(21) Appl. No.: 19/402,931

(22) Filed: Nov. 26, 2025

Related U.S. Application Data
(63) Continuation-in-part of application No. 18/977,529, filed on Dec. 11, 2024.
Application No. 18/977,529 is a continuation-in-part of application No. 18/574,432.
(60) Provisional application No. 63/216,641, filed on Jun. 30, 2021.
(60) Provisional application No. 63/608,695, filed on Dec. 11, 2023.
(60) Provisional application No. 63/615,687, filed on Dec. 28, 2023.
(60) Provisional application No. 63/726,181, filed on Nov. 27, 2024.
(60) Provisional application No. 63/849,363, filed on Jul. 23, 2025.

(51) Int. Cl. B01J 20/20; C01B 32/336

(52) U.S. Cl. CPC B01J 20/20; C01B 32/336; C01P 2004/32; C01P 2006/10; C01P 2006/12; C01P 2006/14

(57) ABSTRACT

A sorbent composition comprises primarily activated carbon with at least most of the particulates of the sorbent composition having a mean and/or median sphericity in the range of from about 0.75 to about 1.0, a total pore volume ranging from about 0.5 to about 0.95 cc/g, a pore volume for pores less than 500 Å ranging from about 0.6 to about 0.8 cc/g, and a BET surface area of at least about 900 m²/g, and one or more of a butane activity (measured by ASTM Method D5742) of more than about 20 wt % and a butane working capacity (measured by ASTM Method D5228) of at least about 5 wt %.

### CROSS REFERENCES

This application claims priority to US Provisional Application Ser. Nos. 63/726,181, filed Nov. 27, 2024, and 63/849,363, filed Jul. 23, 2025, each entitled “TUNING SHAPED GRANULAR ACTIVATED CARBON PORE SIZE DISTRIBUTION AND SURFACE PROPERTIES FOR ENHANCED VOLATILE ORGANIC COMPOUNDS REMOVAL” and is incorporated herein by reference in its entirety.

This application is a continuation-in-part to U.S. patent application Ser. No. 18/977,529, filed Dec. 11, 2024, which claims priority to U.S. Provisional Application Ser. No. 63/608,695, filed Dec. 11, 2023, and 63/615,687, filed Dec. 28, 2023, each entitled “ASSEMBLING AND DENSIFYING ACTIVATED CARBON RAW MATERIALS FOR GRANULAR ACTIVATED CARBON WITH ENHANCED UNIFORMITY AND ADSORPTIVE PROPERTIES” and is incorporated herein by reference in its entirety.

U.S. patent application Ser. No. 18/977,529 is a continuation-in-part to U.S. patent application Ser. No. 18/574,432, filed Dec. 27, 2023, which is a 371 of International Application PCT/US2022/035480, filed Jun. 29, 2022, which claims priority to U.S. Provisional Application Ser. No. 63/216,641, filed on Jun. 30, 2021, each of which are incorporated herein by reference in their entirety.

### FIELD

The disclosure relates generally to shaped sorbents and particularly to shaped activated carbon.

### BACKGROUND OF THE DISCLOSURE

Activated carbon-based sorbent materials, such as those made from lignite coal, Powder River Basin (PRB) coal, bituminous coal, coconut shells, wood, nutshells, cellulose or any other carbon-containing material, are used in powdered (i.e., less than about 177 micron particle size), granular (i.e., greater than about 177 micron particle size) and other sizes and shapes for a host of gas and liquid-phase contaminant removal applications. The activated carbon-based sorbent materials are typically manufactured by heating the raw organic materials that are high in carbon in the absence of oxygen. This process increases the surface area of the carbon, making the sorbent material highly porous and suitable for removing contaminants from liquids, gases, or solids.

The material and form of the activated carbon deployed is highly dependent on the end-use application. In one example for coal-fired power plant flue gas treatment to remove mercury, “small” particle sized powder activated carbon (PAC) is injected into the flue gas and is highly dispersed to contact, convert and capture the mercury. In another example for taste and odor contaminant removal from municipal potable water purification, PAC is dispersed in the raw water and in its highly dispersed form is very effective in removing the contaminants. In yet another example, large-particle granular activated carbons (GAC) are used predominantly in applications employing a stream of contaminated gas or liquid flowing through a column or vessel of packed GAC. In this example, the “large” size GAC particles allow the stream to flow through the packed carbon bed at high flowrates, with low pressure drop and high contact with the contaminant. The GAC not only needs to have the adsorptive (e.g., physiochemical) properties, but it also needs to have sufficient mechanical properties, particularly relating to high hardness and low dustiness for efficient contaminant removal and for proper functioning in process equipment.

A property that gives an indication of the hardness and integrity of a GAC is Ball Pan Hardness (BPH). Particularly, a BPH value indicates the degradation resistance of a GAC. A GAC with a BPH value greater than about 60% is typically considered to have sufficient degradation resistance for use in contaminant removal. As such, GACs produced commercially are made traditionally from dense starting materials, such as bituminous coal, reagglomerated bituminous coal, coconut, etc. that result in hard (e.g., strong) particles that maintain their size and shape during use and typically result in a BPH about 60-95%.

Activation of low-rank coal, sub-bituminous coal or cellulosic material (e.g., wood, fiber, etc.) such as by direct steam, on the other hand, may also be used to produce a GAC with desired adsorptive properties, such as properties beneficial for sequestering a particular target contaminant. In some cases, it may be cheaper to manufacture a GAC from low-rank coal, sub-bituminous coal or cellulosic material. A GAC manufactured from the low-rank coal, sub-bituminous coal or cellulosic material, however, may not exhibit desired mechanical hardness (i.e., BPH less than about 50%) and/or achieve the low dust levels necessary for market application. GAC manufactured from the low-rank coal, sub-bituminous coal or cellulosic material may be considerably more dusty than a GAC manufactured from denser starting materials, such as the bituminous coal, reagglomerated bituminous coal, coconut, etc. (e.g., dust is measured by carbon particles passing a 325 mesh screen of greater than about 0.4 wt %).

### SUMMARY

These and other needs are addressed by the various aspects, embodiments, and/or configurations of the present disclosure.

In accordance with aspects of the present disclosure, a sorbent composition includes primarily activated carbon, at least most of the particulates of the sorbent composition having a mean and/or median sphericity in the range of from about 0.75 to about 1.0, a total pore volume ranging from about 0.5 to about 0.95 cc/g, a pore volume for pores less than 500 Å ranging from about 0.6 to about 0.8 cc/g, and a BET surface area of at least about 900 m²/g, and having at least one of a butane activity (measured by ASTM Method D5742) of more than about 20% and a butane working capacity (measured by ASTM Method D5228) of at least about 5 wt %.

In accordance with aspects of the present disclosure, a sorbent composition includes primarily activated carbon, at least most of the particulates of the sorbent composition having a mean and/or median sphericity in the range of from about 0.75 to about 1.0, a total pore volume ranging from about 0.5 to about 0.95 cc/g, a pore volume for pores less than 500 Å ranging from about 0.6 to about 0.8 cc/g, and a BET surface area of at least about 900 m²/g, and having at least one of a carbon tetrachloride capacity of at least about 50 wt %, a H₂S capacity at least about 0.2 g/cc, and a H₂S loading of at least about 50 wt % (measured by ASTM Method D6646).

In accordance with aspects of the present disclosure, a process includes the steps of providing a carbonaceous feed material comprising at least about 50 wt % carbon, no more than about 10 wt % ash, and a free swelling index of more than about 1 and having a D₅₀ size distribution of no more than about 100 microns; contacting the carbonaceous feed material with at least about 0.1 wt % of a green strength binder and optionally at least about 0.1 wt % of an activation binder to form a feed mixture; homogenizing the feed mixture in a homogenizer to an homogenized feed mixture having a D₅₀ particle size of no more than about 100 um; shaping the homogenized feed mixture in a spheronizer to form spheronized agglomerates, at least most of the spheronized agglomerates having a sphericity ratio ranging from about 0.75 to about 1.0 and an aspect ratio of at least about 0.7; charring, at a charring temperature of no more than about 1,200° F., the spheronized agglomerates in a charring kiln to form charred agglomerates; and activating the charred agglomerates, in the presence of steam and at an activation temperature ranging from about 1,400 to about 2,000° F., to form spherical granular activated carbon particulates, wherein the spherical activated carbon particulates have at least one of a butane activity (measured by ASTM Method D5742) of more than about 20 wt % and a butane working capacity (measured by ASTM Method D5228) of at least about 5 wt %.

In accordance with aspects of the present disclosure, a sorbent composition comprises activated carbon, wherein at least most of the particulates of the sorbent composition can have a sphericity in the range of about 0.75 to about 1.0 and/or an aspect ratio greater than about 0.71.

In accordance with aspects of the present disclosure, a process comprises the steps of:
homogenizing a mixture of a carbonaceous feed material, a green strength binder and water to form a homogenized mixture;
shaping the homogenized mixture in a spheronizer to generate substantially spherically shaped agglomerates;
thermally charring the substantially spherically shaped agglomerates to form charred substantially spherically shaped agglomerates; and
activating the charred substantially spherically shaped agglomerates to produce substantially spherically shaped granular activated carbon.

In accordance with aspects of the present disclosure, a method comprises contacting a plurality of activated carbon sorbent particulates, at least 60% by number of the sorbent particulates having a sphericity ranging from about 0.75 to about 1.0, with a contaminated fluid comprising a target contaminant to form target contaminant-containing sorbent particles containing at least most of the target contaminant in the contaminated fluid and a treated fluid comprising a reduced amount of the target contaminant.

In accordance with aspects of the present disclosure, a sorbent composition can comprise activated carbon, wherein at least most of the particulates of the sorbent composition have a mean and/or median sphericity in the range of about 0.75 to about 1.0, a higher microporosity volume of 0.3-0.5 cc/g, and a higher surface area of 900-1200 m²/g.

In accordance with aspects of the present disclosure, the sorbent composition can comprise additional additives such as, but not limited to, super oxidants.

In accordance with aspects of the present disclosure, the sorbent composition can have a butane working capacity, as measured by ASTM D5228, can be between about 7.0% to about 20 wt %, or between about 10 wt % to about 18 wt %.

In accordance with aspects of the present disclosure, the sorbent composition can have a butane activity percentage, as measured by ASTM D5742, between about 20 wt % to about 32 wt %.

In accordance with aspects of the present disclosure, the sorbent composition can have a butane activity percentage, as measured by ASTM D5742, between about 22 wt % to about 29 wt %.

In accordance with aspects of the present disclosure, the sorbent composition can have a carbon tetrachloride capacity of between about 50 wt % to about 80 wt %, between about 57 wt % to about 74 wt %, or between about 58 wt % to about 72 wt %.

In accordance with aspects of the present disclosure, the sorbent composition can have an acetone adsorption capacity between about 40 wt % to about 50 wt %.

In accordance with aspects of the present disclosure, the sorbent composition can have a methyl ethyl ketone (MEK) adsorption capacity between about 30 wt % to about 45 wt %, between about 32 wt % to about 44 wt %, or between about 35 wt % to about 43 wt %.

In accordance with aspects of the present disclosure, the sorbent composition can have a toluene adsorption capacity between about 90 wt % to about 99 wt % or between about 91 wt % to about 95 wt %.

In accordance with aspects of the present disclosure, the sorbent composition can have a limonene adsorption capacity between about 25 wt % to about 40 wt %, between about 28 wt % to about 39 wt %, or between about 29 wt % to about 38 wt %.

In accordance with aspects of the present disclosure, the sorbent composition can have an apparent density that is between about 0.30 g/cc to about 0.50 g/cc, between about 0.35 g/cc to about 0.45 g/cc, or between about 0.36 g/cc to about 0.43 g/cc.

In accordance with aspects of the present disclosure, the sorbent composition can have an H₂S loading that is between about 50 wt % to about 100 wt %.

In accordance with aspects of the present disclosure, the sorbent composition can have a H₂S capacity that is between about 0.20 g/cc to about 0.40 g/cc, between about 0.22 g/cc to about 0.39 g/cc, or between about 0.23 g/cc to about 0.38 g/cc.

In accordance with aspects of the present disclosure, the sorbent composition can have a H₂S capacity of at least about 0.20 g/cc, at least about 0.25 g/cc, at least about 0.30 g/cc, or at least about 0.35 g/cc.

In accordance with aspects of the present disclosure, the sorbent composition can have a H₂S loading of at least about 55 wt %, at least about 65 wt %, at least about 75 wt %, at least about 85 wt %, or at least about 95 wt %.

In accordance with aspects of the present disclosure, an activated carbon sorbent composition can be manufactured as described using the methods as described herein.

The present disclosure can provide a number of advantages depending on the particular aspect, embodiment, and/or configuration. Granular activated carbons (GACs) produced commercially are made from dense starting materials like bituminous coal, re-agglomerated coal, coconut, etc. that give very strong and hard particles that maintain their size and shape in use. However, most of them are in irregular shape, having a lower sphericity and aspect ratio. The process described in this disclosure can create a GAC product with improved properties including improved charring/coking and activation ability, faster adsorption kinetics (e.g., speed and selectivity of adsorption), reduced pressure drop through a vessel due to a relatively uniform particle size distribution, better reactivation integrity, lower dust, and faster and greater adsorption performance for certain contaminants. The substantially uniform, spherically shaped, high activity activated carbon can have a unique composition for use in contaminant removal from soil, liquid and gas streams. The composition can provide a reduced leaching of trace metals due to the highly pure nature of the raw material, improved adsorption kinetics (rate and selectivity), and improved operational efficiencies, such as higher flowrates, reduced energy consumption, low dustiness and fines creation during handling, improved adsorption capacity for contaminants including drinking water taste and odor compounds, ground and drinking water PFAS, acid gases and VOCs in industrial and biogas applications. The high hardness and high sphericity of the highly activated granular activated carbon of the present disclosure can have a reduced pressure drop (e.g., lower energy consumption and higher flow rates) and abrasion during handling, and a tuned surface and pore properties can prevent leaching of residual constituents (particularly for purified coal raw material) while adsorbing target contaminants from municipal water, groundwater, soils, and sediments. Such spherically shaped granular activated carbon with a micro grain size structure and tuned pore size distribution can accelerate the transportation and sequestration of contaminants into the carbon pores. Specifically, the porosity distribution and microstructure and/or surface charge and hydrophobicity can be tuned for specific contaminants. The increased integrity of the spherically shaped granular activated carbon material can resist multiple cycles of reactivation. This is believed to be due to the high strength properties of the granular activated carbon material from coking/plasticization coupled with a spherical shape without corners that abrade into dust.

These and other advantages will be apparent from the disclosure.

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Absorption” is the incorporation of a substance in one state into another of a different state (e.g. liquids being absorbed by a solid or gases being absorbed by a liquid). Absorption is a physical or chemical phenomenon or a process in which atoms, molecules, or ions enter some bulk phase—gas, liquid or solid material. This is a different process from adsorption, since molecules undergoing absorption are taken up by the volume, not by the surface (as in the case for adsorption).

“Activated carbon” or “AC” refers to an amorphous carbon that has been treated with steam and heat to exhibit strong affinity for adsorbing target contaminants.

“Adsorption” is the adhesion of atoms, ions, biomolecules, or molecules of gas, liquid, or dissolved solids to a surface. This process creates a film of the adsorbate (the molecules or atoms being accumulated) on the surface of the adsorbent. It differs from absorption, in which a fluid permeates or is dissolved by a liquid or solid. Similar to surface tension, adsorption is generally a consequence of surface energy. The exact nature of the bonding depends on the details of the species involved, but the adsorption process is generally classified as physisorption (characteristic of weak van der Waals forces) or chemisorption (characteristic of covalent bonding). It may also occur due to electrostatic attraction.

“Agglomerates” are particle composites formed by smaller particles bonded together, typically by an organic, inorganic, or compound binder, to form larger and stable agglomerates. Agglomeration can occur in a variety of ways, including mechanical, thermal, or chemical methods. An agglomerate of the present disclosure may refer to native coal particles. A re-agglomerate of the present disclosure may refer to or may be referred to as a “granule” or “agglomerate” and may include one or more binding agents.

“Ash” refers to the inorganic—e.g. non-hydrocarbon—mineral component found within most types of fossil fuel, especially that found in coal. Ash is comprised within the solid residue that remains following combustion of coal, sometimes referred to as fly ash. As the source and type of coal is highly variable, so is the composition and chemistry of the ash. However, typical ash content includes several oxides, such as silicon dioxide, calcium oxide, iron (III) oxide and aluminum oxide. Depending on its source, coal may further include in trace amounts one or more substances that may be comprised within the subsequent ash, such as arsenic, beryllium, boron, cadmium, chromium, cobalt, lead, manganese, mercury, molybdenum, selenium, strontium, thallium, and vanadium.

“Binding agent” refers to a material or substance that holds other materials together mechanically and/or chemically to form a cohesive whole and may otherwise be referred to as a “binder”, “binder material,” “bonding agent,” “adhesive,” “adhesion agent,” “connection agent,” “coupling agent,” and “fixing agent.”

The term “carbon-rich” refers to a material comprising at least about 50 wt %, more commonly at least about 55 wt %, more commonly at least about 60 wt %, more commonly at least about 65 wt %, more commonly at least about 70 wt %, more commonly at least about 75 wt %, more commonly at least about 80 wt %, more commonly at least about 85 wt %, and even more commonly at least about 90 wt % (wet or dry basis) carbon or carbon-containing compounds.

“Coal” is used herein to denote readily combustible sedimentary mineral-derived solid hydrocarbonaceous material including, but not limited to, hard coal, such as anthracite; bituminous coal; sub-bituminous coal; and brown coal including lignite (as defined in ISO 11760:2005). “Native” or “feedstock” coal refers coal that has not been subjected to extensive processing and comprises a physical composition (e.g. maceral content) that is substantially unchanged from the point of extraction. In contrast, the terms “coal-derived product”, “coal replacement product” and “purified coal compositions” are used herein to refer to various coals which have been subjected to one or more processes that lead to a change in physical and/or chemical compositions of the coal such that it is substantially changed from the point of extraction—i.e., the natural state.

“Contaminants” as used herein, refers to target contaminants found in selected composition to be treated. Compositions to be treated may include gases such as flue gases, soil, groundwater, municipal water, wastewater, industrial water, wastewater, industrial gases, military gases, biogas, and other fluids or solids. Exemplary contaminants may include inorganic contaminants such as acid gases (including hydrogen sulfide (H₂S)), coal combustion residuals (CCRs), such as arsenic (As), cobalt (Co), lithium (Li), molybdenum (Mo), and boron (B) and volatile organic compounds, such as acetone, methyl ethyl ketone (MEK), benzene, toluene, xylene, limonene and siloxanes, organic contaminants such as (petroleum) hydrocarbons, chlorinated solvents, Per and Polyfluoroalkyl Substances (PFAS including PFOS, PFOA, and additional long and short chain PFAS), taste and odor compounds (including 2-methylisoborneo and geosmin), natural organic matter (including total and dissolved organic carbon), herbicides and pesticides (including atrazine), other micropollutants (including Candesartan, Carbamazepine, Clarithromycin, Diclofenac, Hydrochlorothiazide, Ibuprofen, Irbesartan, metoprolol, Sulfamethoxazole, Iopromide, amisulpride, azithromycin, citalopram, metformin, oxipurinol, valsartan, venlafaxine), chlorinated solvents (including tetrachloroethene, trichloroethene, dichloroethene, vinyl chloride), hydrocarbons (including total petroleum hydrocarbons, benzene, toluene, ethylbenzene, xylenes), and 1,4-Dioxane.

“Diffusion pores” refer to mesopores of an activated carbon-comprising composition, and may otherwise be referred to transportation pores.

“Fixed carbon” refers to the remaining carbon after carbonization process and the activation process, demonstrated by: wt % Fixed carbon=100%−(% volatile matter content−% ash content−% moisture content).

“Hard raw material” refers to dense carbon-comprising materials such as bituminous coal, re-agglomerated bituminous coal, coconut, etc. and may otherwise be referred to as “hard starting material,” “hard sourcing material,” “hard feedstock,” or the like.

The term “hard sorbent composition” refers to a sorbent composition having a ball pan hardness of at least about 80%, or more typically at least about 85%, or more typically at least about 90% and/or an abrasion number of at least about 65%, or more typically at least about 70%, or more typically at least about 75%, or more typically at least about 80%.

The term “low ash coal” refer to native coal that has a proportion of ash-forming components that is lower when compared to other industry standard coals. Typically, a low ash native or feedstock coal will comprise less than around 12 wt % ash. The term “deashed coal”, or the related term “demineralised coal”, is used herein to refer to coal that has a reduced proportion of inorganic minerals compared to its natural native state. Ash content may be determined by proximate analysis of a coal composition as described in ASTM D3174-12 Standard Test Method for Ash in the Analysis Sample of Coal and Coke from Coal. Ash content in purified carbonaceous product derived predominantly from coal is less than 5 wt %, less than 3 wt %, less than 2 wt % and less than 1.5 wt % or even less than 1 wt % are obtained. Indeed, the present inventors have found quite unexpectedly that products having very low ash contents of around or below 1 wt % can be obtained from starting material that is as much as 50 wt % ash without having to sacrifice yield levels that render the process un-commercial.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

A “mill” refers to any facility or set of facilities that comminutes a carbonaceous material into a comminuted material having a reduced particle size. Generally, the mill includes an open or closed comminution circuit, which includes crushers or autogenous, semi-autogenous, or non-autogenous grinding mills.

“Non-coking coal,” as used herein, refers to coal that does not possess the necessary properties for coking and the production of coke such that it cannot soften and re-solidify like coking coal during the coking process. “Non-coking coal” can include bituminous coal, re-agglomerated bituminous coal, and coconut-based coal and may also be referred to as thermal coal or steam coal.

“Sequestration pores” refer to micropores of an activated carbon-comprising composition or pores that are about 1-2 times the molecular diameter of the contaminant of concern.

“Soft raw material” refers to a carbon-comprising material derived from low ranking coal (e.g., sub-bituminous coal, lignite coal, PRB coal) or “soft” starting materials such as cellulosic material (e.g., wood fiber, peat, soft nutshells), and may otherwise be referred to as “soft starting material,” “soft sourcing material,” “soft feedstock,” or the like.

A “sorbent” is a material that sorbs another substance; that is, the material has the capacity or tendency to take it up by sorption.

“Sorb” means to take up a liquid or a gas by sorption.

“Sorption” refers to adsorption and absorption, while desorption is the reverse of adsorption.

“Sphericity” is the ratio of the surface area of a sphere with the same volume as a particle to the particle's actual surface area. A perfect sphere has a sphericity of 1.0.

“Spheronization” or “marumerization” refers to a process where small particulates are agglomerated/assembled and shaped (e.g., the output from a mixer) into typically small, rounded or spherical granules or particulates. The median, mode, and mean particulate size typically ranges from about 0.25 mm to about 10 m and more typically from about 0.4 to about 3 mm in diameter.

A “super oxidant” is a substance that is extremely effective at oxidizing other molecules, such as a superoxide or peroxygen compound (e.g., permanganate or persulfate). A superoxide is a compound that contains the superoxide ion, which has the chemical formula O⁻². Superoxide forms salts with alkali metals and alkaline earth metals. The salts ium superoxide (NaO₂), potassium superoxide (KO₂), rubidium superoxide (RbO₂) and caesium superoxide (CsO₂) are prepared by the reaction of O₂ with the respective alkali metal.

Unless otherwise specified, the term “thermosetting” and “thermally setting” refers to the process of polymerization with irreversible hardening (i.e., curing) of a composition. Thermosetting is induced by heat or suitable radiation and may be promoted by high pressure or mixing with a catalyst.

Unless otherwise specified, the term “thermo charring”, “thermally charring”, and “charring” refers to a process to concentrate the carbon and hydrogen content in a material in preparation of activation. Charring may include dehydration, devolatilization, and removal of hetero-atoms. Charring may also be referred to as “carbonization.” In a non-limiting example, coke and charcoal are both produced by charring. In a non-limiting example, compositions like thermoset, or most solid organic compounds like wood or biological tissue, exhibit charring behavior.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

Unless otherwise noted, all component or composition levels are in reference to the active portion of that component or composition and are exclusive of impurities, for example, residual solvents or by-products, which may be present in commercially available sources of such components or compositions.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTIONS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 shows a simplified block diagram of a system for use in manufacturing spherical granular activated carbon in accordance with an embodiment;

FIG. 2 is a plot of dimension change (%) (vertical axis) vs. time (minute) (horizontal axis) as a function of temperature (° C.) for Thermo-Mechanical Analysis (TMA) of an activated carbon sorbent of an embodiment of the present disclosure;

FIG. 3 is a plot of dimension change (%) (vertical axis) vs. time (minute) (horizontal axis) as a function of temperature (° C.) for Thermo-Mechanical Analysis (TMA) of an activated carbon sorbent of an embodiment of the present disclosure;

FIG. 4 is a plot of Cs (mg/g) (vertical axis) vs. Ceq (mg/L) (horizontal axis);

FIG. 5 is a plot of Cs (mg/g) (vertical axis) vs. Ceq (mg/L) (horizontal axis);

FIG. 6A is a plot of MIB concentration (ng/L) (vertical axis) vs. contact time (hr) (horizontal axis);

FIG. 6B is a plot of TOC concentration (ng/L) (vertical axis) vs. contact time (hr) (horizontal axis);

FIG. 7 is a plot of cumulative pore volume (cc/g) (vertical axis) vs pore width (Å) (horizontal axis);

FIG. 8 is a plot of effluent arsenic concentration (ppb. μg/L) (vertical axis) vs bed volumes of water passed (horizontal axis); and

FIG. 9 is a plot of effluent arsenic concentration (ppb. μg/L) (vertical axis) vs bed volumes of water passed (horizontal axis).

FIG. 10 is a plot of Va/cc (STP)^{g-}1 (vertical axis) vs relative pressure (p/po) (horizontal axis) to provide the full isotherms of methyl ethyl ketone (MEK) adsorption at 25° C.

FIG. 11 is a plot of Va/cc (STP)^{g-}1 (vertical axis) vs relative pressure (p/po) (horizontal axis) to full isotherms of acetone adsorption at 25° C.

FIG. 12 is a plot of Va/cc (STP)^{g-}1 (vertical axis) vs relative pressure (p/po) (horizontal axis) to full isotherms of limonene adsorption at 25° C.

FIG. 13 is a plot of quantity adsorbed (cc/g STP) (vertical axis) vs relative pressure (p/po) to provide full isotherms of toluene adsorption at 25° C. for AirLoq 410 VOC1.

FIG. 14 is a plot of quantity adsorbed (cc/g STP) (vertical axis) vs relative pressure (p/po) to provide full isotherms of toluene adsorption at 25° C. for 4×8 GAC (coconut).

### DETAILED DESCRIPTION

In various embodiments, the present disclosure describes an improved composition, method and use for substantially spherically shaped, densified and uniform activated carbon sorbent for treatment of contaminants in air, soil and, surface, ground, and wastewater. The substantially uniform, spherically shaped, and high activity carbon sorbent can have a high hardness (e.g., be a hard sorbent composition), aspect ratio close to one (e.g., width/length ratio), narrow size distribution, improved physical integrity, and/or tuned surface properties (e.g., micro-grain size structure) and pore size distribution to accelerate the transportation and sequestration of contaminants into the carbon pore for enhanced adsorption capability. By tuning and homogenizing the raw material, feed preparation (e.g., assembling with a green strength binder and optionally an activation binder, shaping and densifying the raw material in a spheronizer (such as a pin mixer or other spheronizing device) into large spherical granules), and charring/coking/thermal activation profile with steam under controlled conditions when producing granular activated carbon (GAC), the final GAC product can have a high sphericity, close to 1 aspect ratio, preferred porosity, surface functionalities, and structural and adsorptive properties for removal of target contaminants in any fluid medium or soil, such as volatile organic compounds or VOCs, hydrogen sulfide, siloxane, Taste and Odor contaminants in drinking water, PFAS, acid gases, etc. The additive is particularly useful in industrial gas and biogas treatment and pre-treatment, pressure and temperature swing adsorption columns, and other treatment vessels. Optionally, additives (discussed below) may be incorporated into the carbonaceous feedstock and the activated carbon product for improved adsorption selectivity, capacity, catalytic effects, and/or reduced leaching of impurities.

The present disclosure can employ an improved set of activation conditions to make shaped, densified and uniform activated carbon that can be formed in granular activated carbon (GAC) for treatment of volatile organic compounds (VOCs) in air, soil and ground water, especially in biogas pre-treatment. The disclosure can employ a highly purified, small particle sized bituminous based coal product as a raw material.

The sorbent can be based on (e.g., as the primary sorbent), or incorporates (e.g., as a binder), a carbonaceous material as described in U.S. patent application Ser. No. 18/977,529. Stated differently, the carbonaceous material described in copending U.S. patent application Ser. No. 18/977,529 can be used as a shaped base sorbent or as a binder for other shaped carbonaceous materials, such as activated carbon provided by a different process and having a different composition.

The raw materials are typically homogenized and then assembled, shaped and densified into granules, more desirably into substantially spherical granules, such as 4×10 mesh. Typically at least most (i.e., at least about 50%), more typically at least about 60%, more typically at least about 70%, at least about 75%, more typically at least about 80%, more typically at least about 85%, more typically at least about 90%, and more typically at least about 95% of the spheronized granulized material typically have a size ranging from about 0.2 to about 7.5 mm, more typically from about 0.25 to about 6 mm, and more typically from about 0.4 to about 5 mm.

The spheronized granulized material can be formed from a carbonaceous feedstock including through homogenizing and reassembling with a green strength binder and optionally an activation binder in a spheronizer such as a pin mixer, disc/pan pelletizer or other spheronizing equipment to generate the shaped granules. The spheronized granulized material can be made from different carbonaceous materials. Purified coal products can be produced from grinding, washing and drying cycles depending on the applications (as further described in U.S. patent application Ser. No. 18/977,529, which is herein incorporated by reference in its entirety). The homogenized size of the carbonaceous material, along with pre-mixed binders (green strength and activation binders), are fed into pin mixer or other spheronizer with water added to assemble and densify the carbonaceous feed into pre-determined sized granules that can be activated. The shaping/densifying conditions can be tuned to get the optimized screening yield for the targeted large granules. The carbonaceous granules can be screened as needed.

The GAC is typically produced through charring (to dehydrate, devolatilize, and carbonize) in a kiln and thermally activating (with steam to create surface area and porosity) in a high temperature furnace, such as a rotary kiln or a multi-hearth furnace. Charring of the densified spheronized granulized material is typically performed in a highly controlled process discussed below to control the thermosetting/coking properties of the raw material and thermally activated under unique, highly tuned conditions to yield a product with high sphericity and aspect ratio typically in the range of about 0.75 to about 1.0 and more typically about 1.0, and enhanced hardness and contaminant adsorption activity. Typically, at least most (i.e., at least about 50% by number), more typically at least about 60%, more typically at least about 70%, more typically at least about 75%, more typically at least about 80%, more typically at least about 85%, more typically at least about 90%, and more typically at least about 95% of the sorbent particles have a high sphericity as defined above.

Charring and thermally activating the densified spheronized granulized material is typically performed under unique, highly tuned conditions to yield a product with high sphericity and low aspect ratio, and enhanced hardness and adsorption activity for VOCs that can be used in the pressure and temperature swing adsorption columns. The set of activation conditions typically uses an activation temperature of at least about 1500° F., more typically at least about 1600° F., and more typically at least about 1700° F. but typically no more than about 2000° F., more typically no more than about 1900° F., and more typically no more than about 1800° F. The residence time during activation typically is at least about 75, more typically at least about 90, and more typically at least about 105 minutes but typically no more than about 200, more typically no more than about 175, and more typically no more than about 150 minutes. The steam to fixed carbon weight ratio is at least about 2.5:1, more typically at least about 3:1 and more typically at least about 3.5:1.

While not wishing to be bound by any theory, it is believed that process increases the microporosity volume of the activated carbon due to increased gas penetration into the surfaces pores. Typically, the activated carbon has a micropore volume of at least about 0.3 cc/g and more typically of at least about 0.35 cc/g and more typically of at least 0.4 cc/g; A BET surface area of at least about 900 m²/g, and more typically of at least about 1000 m²/g, and more typically of at least 1100 m²/g, and even more typically of about 1200 m²/g. The carbon tetrachloride capacity of the activated carbon is typically at last about 50 wt %, more typically at least about 65 wt %, more typically at least about 70 wt %, more typically at least about 75 wt %, and more typically at least about 80 wt %.

The activated carbon sorbent can provide enhanced contaminant removal from the soil, liquid and gas streams as well as enhanced operational performance in a treatment vessel, such as for hydrogen sulfide and siloxane removal.

The substantially uniform spherically shaped large granules can have high hardness, close to 1 aspect ratio (width/length), improved physical integrity, and enhanced adsorption capability. By tuning the raw material, feed preparation, and thermal activation profile when producing granular activated carbon, the final GAC product has preferable surface functionalities, structural and adsorptive properties for target contaminants, such as VOCs, hydrogen sulfide and siloxane in the biogas stream. Optionally, additives may be incorporated into the carbonaceous feedstock and the activated carbon product for improved adsorption selectivity, capacity, catalytic effects, and the removal of multiple contaminants at the same time. The spherical shape and size of the GAC can provide high hardness, low pressure drop with improved operational efficiencies, such as higher flowrates, reduced energy consumption, low dustiness, improved adsorption capacity for contaminants including acid gases, siloxane and VOCs in industrial and biogas applications.

The granular activated carbon can reduce substantially generation of larger macropores that contribute nominally to adsorption capacity but reduce carbon density and activation yield.

The spherically shaped activated carbon sorbent can be made from different carbonaceous materials. The raw material can be any carbonaceous material, such as anthracite coal, bituminous coal, subbituminous coal, lignite coal, remediated coal waste and other non-coking coals, coconut, pecan husks, olive pit, peat, wood, other hard or soft raw materials, or a blend of the foregoing. These raw materials can be used as a starting raw feed material for the process either as is or after further treatment to remove impurities, such as ash. The treated or purified carbonaceous material can be produced from grinding, washing and drying cycles depending on the applications. In either case, the raw feed material is typically a free-flowing particulate material having a relatively small particle size.

The raw carbonaceous material, whether purified in whole or part, can be homogenized and then assembled, shaped and densified into agglomerates or granules, more desirably into substantially spherical granules, such as by a spheronizer. The homogenized carbonaceous material, optionally pre-mixed with green strength and/or activation binders are typically fed along with water into a spheronizer, such as a pin mixer, disc/pan pelletizer or other spheronizing equipment, to (re) assemble and densify the carbonaceous materials into pre-determined sized shaped granules. The carbonaceous granules can be screened as needed. The process can be controlled to produce a high shaping yield. Using the purified carbonaceous product described above can provide the advantage of much smaller grain sizes and pre-conditioning, such as pre-oxidation and trace metal removal during washing and drying steps.

The densified carbonaceous material can be converted into GAC through charring (to dehydrate, devolatilize, and carbonize) in a highly controlled process to control the thermosetting/coking properties of the densified carbonaceous material followed by thermally activating (typically with steam to create surface area and porosity) under highly tuned conditions in a high temperature furnace, such as a rotary kiln or a multi-hearth furnace to yield an agglomerated activated carbon or densified spheronized granulized material having a substantially spherical shape.

The densified spheronized granulized material can be charred and thermally activated to yield a spherically shaped activated carbon sorbent with high sphericity typically in the range of about 0.75 to about 1.0, more typically in the range of about 0.85 to about 1.0, more typically in the range of about 0.9 to about 1.0, more typically in the range of about 0.95 to about 1.0, and more typically about 1.0, and aspect ratio typically in the range of at least about 0.7, more typically of more than about 0.75, and more typically of more than about 0.8 and enhanced hardness and contaminant adsorption activity. Typically, at least most (i.e., more than about 50%), more typically at least about 60%, more typically at least about 70%, more typically at least about 75%, more typically at least about 80%, more typically at least about 85%, more typically at least about 90%, and more typically at least about 95% of the sorbent particles have a high sphericity and aspect ratio as defined above.

At least most (i.e., more than about 50%), more typically at least about 60%, more typically at least about 70%, at least about 75%, more typically at least about 80%, more typically at least about 85%, more typically at least about 90%, and more typically at least about 95% of the spherically shaped activated carbon sorbent typically has a particle size ranging from about 0.2 to about 7.5 mm, more typically from about 0.25 to about 6 mm, and more typically from about 0.4 to about 5 mm or stated differently typically of at least 4×10 mesh size, more typically of at least 4×8 mesh size, and more typically of at least 4×6 mesh size.

The spherically shaped activated carbon sorbent can be used to remove contaminants in air, soil, and surface, ground, and wastewater. The spherically shaped activated carbon sorbent can realize enhanced contaminant removal not only from the soil, liquid and gas streams but also through enhanced operational performance in a treatment vessel.

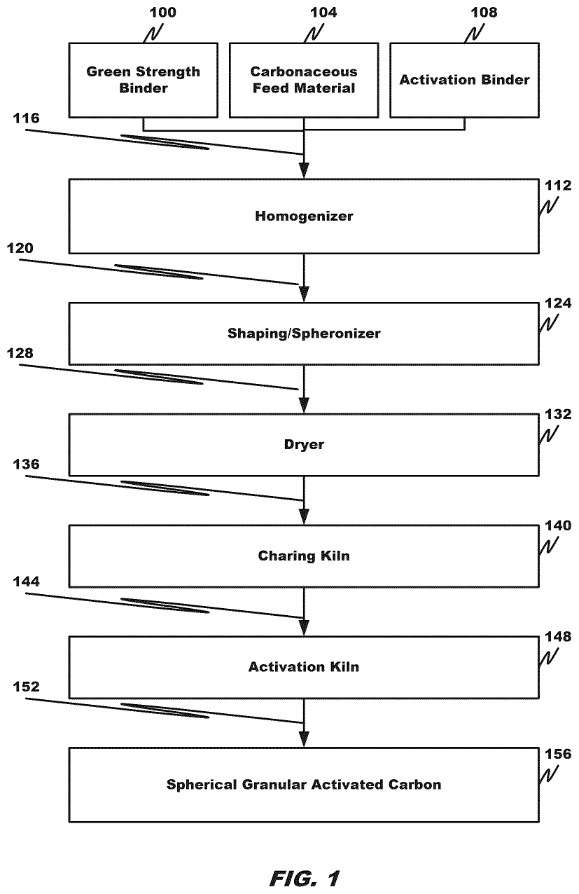

A process to manufacture the spherically shaped activated carbon sorbent will be discussed in connection with FIG. 1.

In a first step, a green strength binding agent or binder 100, carbonaceous feed material 104, and activation binding agent or binder 108 are blended and homogenized in a homogenizer 112 to form a homogenized feed mixture 120. Depending on the application, the green strength binding agent or activation binding agent may or may not be used.

The green strength binding agent 100 can be any suitable green strength binder that increases the green strength of agglomerates formed from the homogenized carbonaceous feed material. Examples of green strength binding agents include without limitation carboxymethyl cellulose, carboxymethylhydrocellulose (CMHC), hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethyl-methyl cellulose, enriched methyl-hydroxypropyl cellulose MHPC, and other cellulose derivatives, xanthan gum and derivatives thereof, guar gum and derivatives thereof (such as hydroxypropyl guar gum), tragacanth gum and derivatives thereof, polyacrylates and derivatives thereof (e.g., acrylates/C10-C30 alkyl acrylate cross-polymer, carbomer, and polyacrylate-1 cross-polymer), agarose, casein, starch, poly(vinylidene difluoride) (PVDF), poly [1-(2-oxo-1-pyrrolidinyl)ethylene] (POPE), polytetrafluoroethylene (PTFE), n-methyl-2-pyrrolidone (NMP), polyvinylidene fluoride (PVDF), and other natural polymers, gelatin, chitosan, alginate, other organic and inorganic binders, and mixtures thereof.

The carbonaceous feed material 104 can be any hard or soft carbon-rich raw material, such as anthracite coal, bituminous coal, subbituminous coal, lignite coal, and other non-coking coals, coconut, pecan husks, olive pit, peat, wood, other hard or soft raw materials, or a blend of the foregoing. The carbonaceous feed material can be reclaimed from waste reserves, naturally occurring materials such as coal, and have a low carbon dioxide footprint. The carbonaceous feed material 104 typically has an ash content of no more than about 10 wt %, more typically no more than about 9 wt %, more typically no more than about 8 wt %, more typically no more than about 7 wt %, more typically no more than about 6 wt %, and more typically no more than about 5 wt %, a free swelling index of typically more than about 1 and more typically more than about 2 but typically no more than about 5. The carbonaceous feed material 104 typically has a D₅₀ size distribution of no more than about 100 microns, more typically no more than about 80 microns, more typically no more than about 70 microns, more typically no more than about 60 microns, more typically no more than about 50 microns, more typically no more than about 40 microns, more typically no more than about 30 microns, more typically no more than about 20 microns, and more typically no more than about 10 microns.

In some applications, the carbonaceous feed material 104 is a purified, typically small, particle-sized coal product or similar carbon-rich feed material. The purified carbonaceous feed material typically has an ash content of less than about 5 wt %, more typically less than about 4 wt %, more typically less than about 3 wt %, more typically less than about 2 wt %, and more typically less than about 1 wt %. The purified carbonaceous feed material 104 in such applications can be a carbonaceous feed material optionally subjected to froth flotation to separate hydrophobic materials in an overflow from hydrophilic materials in an underflow. Most of the ash is removed in the underflow while the carbonaceous feed material is removed in the overflow. The ash removal process and resulting purified carbonaceous feed material is further discussed in copending U.S. Pat. No. 18,574,432, filed Jun. 29, 2022 (now published as US20240317589), which is incorporated fully herein by this reference. In the process, the raw carbonaceous material is milled to a particle size of D50 size typically ranging from about 1-20 microns; the milled material formed into a slurry having a typical solids content in the range of about 5-40 wt % solids; the ash and other mineralized hydrophobic materials separated from the hydrophilic coal by floating the slurry in one or more stages of froth flotation in the presence of a suitable frother (e.g., methyl iso-butyl carbinol and pine oil) and collector (e.g., diesel fuel or other hydrocarbon oil, and Nasmin AP7™ from Nasaco International Company; the hydrophilic materials containing coal particles is dewatered, such as by a filter press or tube press to a target range of typically about 20-50 wt % solids and about 50-80 wt % water under pressure or vacuum to form a dewatered coal-containing product; and the dewatered coal-containing product dried thermally to form the purified carbonaceous material having a reduced water content of no more than about 10 wt % water. In other applications, most of the ash and other mineralized content is removed from the carbonaceous feed material through milling, washing and drying cycles The dried purified carbonaceous material has thermoplastic/free swelling/coking properties that can be carefully controlled in the charring step to reduce inter-primary particle void space within the shaped granules and realize an enhanced intra-granule pore characteristic for enhanced contaminant adsorption selectivity, capacity and kinetics.

The purified carbonaceous feed material can be used as a green strength binder for agglomerates formed from the carbonaceous feed material 104. Stated differently, the purified carbonaceous material described in the above-referenced application can be used as a green strength binder for the higher ash carbonaceous feed material.

The activation binding agent 108 can be any suitable activation binder that enhances the integrity and shaping of the carbonaceous material at the activation temperature. Exemplary activation binding agents include without limitation phenol-formaldehyde resin, polyvinyl acetate, gilsonite, resinous rock, asphalt, uintahite, coal tar pitch, petroleum pitch, oil sands, bitumen, resinous hydrocarbon, heavy oil, carbon pitch, coal tar distillates, clays such as bentonite, gas generator tar, and mixtures thereof.

The feed mixture 116 typically comprises from about 0.1 to about 15 wt %, more typically from about 0.1 to about 10 wt %, more typically from about 0.15 to about 7.5 wt %, more typically from about 0.25 to about 5 wt %, and more typically from about 0.5 to about 2 wt % of the green strength binder 100, from about 0 to about 10 wt %, more typically from about 0.1 to about 10 wt %, more typically from about 0.1 to about 7.5 wt %, more typically from about 1 to about 5 wt %, and more typically from about 2 to about 4 wt % of the activation binder 100, and typically from about 5 to about 30 wt % and even more typically from about 10 to about 25 wt % water, with the balance being the carbonaceous feed material 104. The activation binder can be omitted when the carbonaceous feed material inherently has sufficient coking properties. Coking coals are typically coals that soften, swell and then solidify as they are heated through the temperature range 350-550° C. Such coals commonly have a low ash content (e.g., from about 1-10 wt %), a low permeability as determined by inherent moisture, a moderate vitrinite content (to provide volatile matter) and volatile matter typically in the range 18-45 wt %.

The feed mixture 116 is next subjected to homogenization in the homogenizer 112 to form the homogenized feed mixture 120. Homogenization typically synergistically mixes the various components to form a substantially homogenous mixture. The homogenizer 112 can be any mechanical mixing device, such as a paddle mixer, pug mill, and the like. Mixing is performed for a sufficient time to provide a homogenized feed material 120 that has a delumped or aggregated coal reduced D₅₀ particle size to typically no more than about 100 μm, more typically no more than about 50 μm, and more typically less than about 20 μm. The homogenized feed mixture 120 optionally has a moisture content of typically at least about 5 wt % and more typically at least about 10 wt % but typically no more than about 40 wt %, more typically no more than about 30 wt %, and more typically no more than about 25 wt %.

The homogenized feed mixture 120 is shaped and spheronized in step 124 to form spheronized agglomerates 128. The spheronized agglomerates 128 have a high sphericity and aspect ratio typically in the range of about 0.75 to about 1.0 and more typically about 0.9. Typically, at least most (i.e., more than about 50%), more typically at least about 60%, more typically at least about 70%, more typically at least about 75%, more typically at least about 80%, more typically at least about 85%, more typically at least about 90%, and more typically at least about 95% of the spheronized agglomerates 128 have a high sphericity as defined above. The shaping and spheronization can be performed using any suitable device, such as an extruder, tablet press, pin mixer, marumerizer, or other spheronization equipment. As will be appreciated, extrusion is generally performed prior to spheronization. The size of the spheres is determined by the diameter of the homogenized feed mixture used for the spheronization process. For example, to obtain spheres with a diameter of 1 mm, a 1 mm screen can be used on an extruder, although spheres with a slightly bigger diameter can sometimes be obtained. In the spheronizer, the diameter of the spherical agglomerates typically ranges from about 0.2 mm to about 10 mm.

In a typical spheronizer, a rotating friction disk increases friction with the product, which spins at a high speed at the bottom of a cylindrical bowl. The spinning friction disc has a carefully designed groove pattern on the processing surface. This pattern is most often crosshatched, but several sizes and other types are available. The homogenized feed mixture 120 is charged to the spheronizer and fall on the spinning disc. At first, the cylindrical homogenized feed mixture segments are cut into segments with a length ranging from 1 to 1.2 times the diameter. These segments then collide with the bowl wall and are thrown back to the inside of the friction plate. Centrifugal force sends the material to the outside of the disc. The action of the material being moved causes the homogenized feed mixture to be broken down into pieces of approximately equal length relative to the diameter of the homogenized feed mixture. These cylindrical segments are gradually rounded by the collisions with the bowl wall, the plate and each other. The ongoing action of particles colliding with the wall and being thrown back to the inside of the plate creates a “rope-like” movement of product along the bowl wall. The continuous collision of the particles with the wall and friction plate gradually turn the cylindrical segments into spheres, provided that the granules are plastic enough to allow the deformation without being destroyed. When the particles have obtained the desired spherical shape, the discharge valve of the chamber is opened and the granules are discharged by the centrifugal force. The shaping yield is typically at least about 85%, more typically at least about 90%, and more typically at least about 95%.

The spheronized agglomerates are dried in drying step 132 to create a green strength typically of more than about 45% Ball Pan Hardness (BPH), more typically of more than about 60% BPH, and more typically of more than about 80% BPH. The drying temperature is typically less than about 400° F., more typically less than about 300° F., and more typically less than about 200° F. After drying, the water content of the dried spheronized agglomerates 136 is typically no more than about 40 wt % and more typically no more than about 30 wt %. The spheronized agglomerates typically have an ash content of no more than about 15 wt % and even more typically no more than about 10 wt % (dry basis) for municipal water purifications and ash content of no more than 30 wt %, even more typically no more than about 25 wt %, and even more typically no more than about 20 wt % for non-municipal applications.

The dried spheronized agglomerates 136 are charred in a charring kiln 140 to form charred agglomerates 144. The charring kiln 140 can be any suitable type of kiln, such as a direct or indirect fired counter-current or co-current rotary kiln. The dried spheronized agglomerates 136 are thermally dehydrated, devolatilized and carbonized in the charring kiln at temperature typically no higher than about 1200° F., more typically no more than about 1100° F., more typically no higher than about 1000° F., and more typically no higher than about 800° F. The purge gas during charring typically has a molecular oxygen level of no more than about 10 vol %, more typically no more than about 5 vol %, and more typically no higher than about 2 vol %. The charred agglomerates 144 have a moisture content of typically no more than about 15 wt %, more typically no more than about 10 wt %, and more typically no more than about 5 wt % moisture, and a volatile matter content of less than about 20 wt %. While not wishing to be bound by any particular theory, it is believed that the heating of the coal feed through the multistage dryer drives the moisture off the surface of the dried spheronized agglomerates 136 and by diffusion the moisture in the center of the dried spheronized agglomerates 136 is drawn to the surface of the coal feed particle. The heating is such that the center of the dried spheronized agglomerates 136 is not heated sufficiently to cause the moisture or volatile matter to crack off, thus limiting the fracturing of the dried spheronized agglomerates 136 by evolution of moisture or volatile matter in a gas form from the center of the dried spheronized agglomerates 136. In some applications using a rotary kiln, the rotary kiln will typically have a rotation speed of about 0.5-4 rpm depending on the size of the dried spheronized agglomerates and the size of the rotary kiln heat tube.

The charred agglomerates 144 are thermally activated 148 in an activation kiln or high temperature furnace, such as a rotary kiln or a multi-hearth furnace, to produce spherical granular activated carbon particulates 156. Activation is typically thermally activated at temperatures range from about 1400° F. to about 2000° F., more typically from about 1500° F. to about 1900° F., and more typically from about 1600° F. to about 1800° F. The steam-to-fixed carbon ratio typically ranges from about 5:1 to about 0.5:1, more typically from about 4:1 to about 0.8:1, and more typically from about 3.5:1 to about 1:1.

The spherical granular activated carbon sorbent particulates 156 or activated carbon sorbent typically include a carbon content of at least about 75 wt %, more typically at least about 80 wt./%, more typically at least about 85 wt %, and more typically at least about 90 wt % and can have a high activity, a high hardness (e.g., be a hard sorbent composition), a high aspect ratio (e.g., width/length ratio), an improved physical integrity, and/or an enhanced adsorption capability. The spherical granular activated carbon sorbent particulates 156 typically have one or more of: a sphericity ranging from about 0.86 and about 1.0, more typically between about 0.90 and about 1.0, and more typically between about 0.95 and about 1.0; an aspect ratio typically greater than about 0.71, more typically greater than about 0.75, and more typically greater than about 0.80; a dustiness typically less than about 0.2 wt % and more typically less than about 0.1 wt %; a ball pan hardness typically greater than about 60%, more typically greater than about 75%, more typically greater than about 80%, more typically greater than about 90%, and more typically greater than about 95%; an abrasion number typically greater than about 60%, more typically greater than about 75%, and even more typically greater than about 80%; an apparent density of 8×30 size typically ranging from about 0.3 to 0.7 g/cc, more typically ranging from about 0.35 to 0.65 g/cc, and more typically ranging from about 0.45 to 0.55 g/cc; an apparent density of 12×40 size typically ranging from about 0.3 to 0.7 g/cc, more typically ranging from about 0.4 to 0.65 g/cc, and more typically ranging from about 0.45 to 0.55 g/cc; a mercury intrusion particle density typically below about 0.95 g/cc, and more typically below about 0.9 g/cc; a pH range for particulates typically above about 7.5 and more typically above about 8.5; a micropore volume typically of at least about 0.35 cc/g, more typically at least about 0.36 cc/g, more typically at least about 0.37 cc/g, and more typically at least about 0.38 cc/g; a mesopore volume typically of more than about 0.25 cc/g, more typically at least about 0.26 cc/g, more typically at least about 0.27 cc/g, and more typically at least about 0.28 cc/g; a small mesopore volume typically of more than about 0.17 cc/g, more typically at least about 0.18 cc/g, more typically at least about 0.19 cc/g, more typically at least about 0.20 cc/g, more typically at least about 0.21 cc/g, and more typically at least about 0.22 cc/g; a DFT micro+mesopore volume typically of more than about 0.57 cc/g, more typically at least about 0.58 cc/g, more typically at least about 0.59 cc/g, more typically at least about 0.60 cc/g, more typically at least about 0.61 cc/g, more typically at least about 0.62 cc/g, more typically at least about 0.63 cc/g, more typically at least about 0.64 cc/g, and more typically at least about 0.65 cc/g; and a TGA wt. loss % (400 to 750° C.) typically of no more than about 0.35%, more typically no more than about 0.30%, and more typically no more than about 0.25%.

Compared to conventional activated carbon particulates, the spherical granular activated carbon particulates 156 can have a BET (Brunauer-Emmett-Teller) surface area (e.g., measured by Nitrogen Porosimetry) of at least double, optionally more than double, even up to a three-fold increase and more favorable average pore diameter and pore volume (e.g., as modeled by DFT) for contaminant removal. The BET surface area can typically be at least about 500 m²/g and more typically at least about 1000 m²/g; the DFT micro+mesopore volume ranges from about 0.3 to about 0.9 cc/g and more typically from about 0.5 to about 0.7 cc/g.

The BET surface area of the spherical granular activated carbon particulates 156 can more commonly be at least about 900 m²/g, at least about 920 m²/g, at least about 940 m²/g, at least about 960 m²/g, at least about 980 m²/g, at least about 1000 m²/g, at least about 1020 m²/g, at least about 1040 m²/g, at least about 1060 m²/g, at least about 1080 m²/g, at least about 1100 m²/g, at least about 1120 m²/g, at least about 1140 m²/g, at least about 1140 m²/g, or even at least about 1150 m²/g.

The total pore volume of the activated carbon sorbent 156 for all pores can be between about 0.50 cc/g to about 0.95 cc/g. More commonly, the total pore volume for all pore sizes can be between about 0.55 cc/g to about 0.90 cc/g. In embodiments, the total pore volume for all pore sizes can be at least about 0.55 cc/g, at least about 0.60 cc/g, at least about 0.65 cc/g, at least about 0.70 cc/g, at least about 0.75 cc/g, at least about 0.80 cc/g, at least about 0.85 cc/g, or at least about 0.90 cc/g. Additionally or alternatively, in embodiments, the total pore volume for all pore sizes can be commonly no more than about 0.95 cc/g and more commonly no more than about 0.90 cc/g.

The total pore volume of the activated carbon sorbent 156 for pores less than 500 Å, which comprises mesopores and micropores, can be between about 0.60 cc/g to about 0.80 cc/g. More commonly, the pore volume for pores less than 500 Å can be between about 0.62 cc/g to about 0.78 cc/g, or between about 0.62 cc/g to about 0.75 cc/g. In embodiments, the total pore volume for pores less than 500 Å can be at least about 0.60 cc/g, at least about 0.61 cc/g, at least about 0.62 cc/g, at least about 0.63 cc/g, at least about 0.64 cc/g, at least about 0.65 cc/g, at least about 0.66 cc/g, at least about 0.67 cc/g, at least about 0.68 cc/g, at least about 0.69 cc/g, at least about 0.70 cc/g, at least about 0.71 cc/g, at least about 0.72 cc/g, at least about 0.73 cc/g, at least about 0.74 cc/g, or at least about 0.75 cc/g. In embodiments, additionally or alternatively, the total pore volume for pores less than 500 Å can be commonly no more than about 0.80 cc/g, commonly no more than about 0.79 cc/g, commonly no more than about 0.78 cc/g, commonly no more than about 0.77 cc/g, commonly no more than about 0.76 cc/g, or commonly no more than about 0.75 cc/g.

The mesopore volume of the activated carbon sorbent 156, where the pores are inclusively between 20 Å through 500 Å, can be between about 0.20 cc/g to about 0.40 cc/g. In embodiments, the mesopore volume can be at least about 0.20 cc/g, at least about 0.21 cc/g, at least about 0.22 cc/g, at least about 0.23 cc/g, at least about 0.24 cc/g, at least about 0.25 cc/g, at least about 0.26 cc/g, at least about 0.27 cc/g, at least about 0.28 cc/g, at least about 0.29 cc/g, at least about 0.30 cc/g, at least about 0.31 cc/g, at least about 0.32 cc/g, at least about 0.33 cc/g, at least about 0.34 cc/g, or at least about 0.35 cc/g. Additionally or alternatively, in embodiments, the mesopore volume can be commonly no more than about 0.40 cc/g, commonly no more than about 0.39 cc/g, commonly no more than about 0.38 cc/g, commonly no more than about 0.37 cc/g, commonly no more than about 0.36 cc/g, or commonly no more than about 0.35 cc/g.

The micropore volume of the activated carbon sorbent 156, where the pores are equal to or less than 20 Å, can be between about 0.30 cc/g to about 0.50 cc/g. In embodiments, the micropore volume can be at least about 0.30 cc/g, at least about 0.31 cc/g, at least about 0.32 cc/g, at least about 0.33 cc/g, at least about 0.34 cc/g, at least about 0.35 cc/g, at least about 0.36 cc/g, at least about 0.37 cc/g, at least about 0.38 cc/g, at least about 0.39 cc/g, at least about 0.40 cc/g, at least about 0.41 cc/g, at least about 0.42 cc/g, at least about 0.42 cc/g, at least about 0.43 cc/g, at least about 0.44 cc/g, or at least about 0.45 cc/g. In embodiments, additionally or alternatively, the micropore volume can be commonly no more than about 0.50 cc/g, commonly no more than about 0.49 cc/g, commonly no more than about 0.48 cc/g, commonly no more than about 0.47 cc/g, commonly no more than about 0.46 cc/g, or commonly no more than about 0.45 cc/g.

The spherical granular activated carbon sorbent particulates 156 or activated carbon sorbent can have an iodine number of between about 800 mg/g to about 1200 mg/g. In embodiments, the iodine number can be at least about 900 mg/g, at least about 925 mg/g, at least about 950 mg/g, at least about 975 mg/g, at least about 1000 mg/g, at least about 1025 mg/g, at least about 1050 mg/g, at least about 1075 mg/g, or at least about 1100. In embodiments, the iodine number can commonly be no more than about 1150 mg/g, commonly no more than about 1125 mg/g, and commonly no more than about 1100 mg/g.

The H₂S capacity of the activated carbon sorbent 156 can be between about 0.20 g/cc to about 0.50 g/cc. In embodiments, the H₂S capacity can be at least about 0.20 g/cc, at least about 0.25 g/cc, at least about 0.30 g/cc, at least about 0.35 g/cc, at least about 0.40 g/cc, or at least about 0.45 g/cc. Additionally or alternatively, in embodiments, the H₂S capacity can be commonly no more than about 0.50 g/cc, or commonly no more than about 0.45 g/cc.

The H₂S loading of the activated carbon sorbent 156 can be between about 50 wt % to about 100 wt %. More commonly, the H₂S loading can be between about 55 wt % to about 100 wt % or between about 56 wt % to about 100 wt %. More commonly, the H₂S loading can be at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 100 wt %.

Additives can be incorporated into the spherical granular activated carbon particulates or activated carbon sorbent 156 to provide even more enhanced physical properties. For example, the additives can include iron sulfide compounds, metal oxides (such as magnesium oxide (MgO), calcium oxide (CaO), aluminum oxide (Al₂O₃), and activated alumina goethite (FeO(OH)), cationic minerals (catalysts), super oxidants (such as, but not limited to, permanganates and persulfates), and metal hydroxides and combinations thereof, among others. The additives may be added during feed preparation steps, during activation, and/or post activation. When metal oxide is added, the homogenized feed mixture typically comprises at least about 0.05, more typically at least about 0.15, and more typically at least about 0.5 wt. % (dry basis) metal oxide but typically no more than about 7, more typically no more than about 8, and more typically no more than about 10 wt. % (dry basis) metal oxide.

When super oxidant is added, the homogenized feed mixture typically comprises at least about 0.01, more typically at least about 0.05, more typically at least about 0.15, and more typically at least about 0.5 wt. % (dry basis) metal oxide but typically no more than about 7, more typically no more than about 8, and more typically no more than about 10 wt. % (dry basis) super oxidant.

Spherical granular activated carbon particulates or activated carbon sorbent 156 can have a butane activity (measured by ASTM D5742) of between about 18 wt % to about 40 wt %, or more commonly between about 20 wt % to about 32 wt %. More commonly, the butane activity can be at least about 20 wt %, at least about 22 wt %, at least about 24 wt %, at least about 26 wt %, at least about 28 wt %, at least about 30 wt %, or at least about 32 wt %.

The spherical granular activated carbon sorbent particulates 156 or activated carbon sorbent can have a carbon tetrachloride capacity of at least about 45 wt % to about 90 wt % and more typically of at least about 50 wt % to about 80 wt %. More commonly, the carbon tetrachloride capacity can be at least about 50 wt %, at least about 55 wt %, at least about 60 wt %, at least about 65 wt %, at least about 70 wt %, at least about 75 wt %, or at least about 80 wt % carbon tetrachloride capacity. The spherical granular activated carbon particulates 156 can have a butane working capacity (measured by ASTM D5228) of between about 5 wt % to about 20 wt %. More commonly, the butane working capacity can be at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, or at least about 20 wt %.

Spherical granular activated carbon particulates or activated carbon sorbent 156 can have an acetone adsorption isotherm (at 25° C.) of about 40 wt % to about 50 wt %. More commonly, the acetone adsorption capacity can be between about 41 wt % to about 49 wt %, between about 42 wt % to about 48 wt %, between about 42 wt % to about 47 wt %, or between about 43 wt % to about 46 wt %.

Spherical granular activated carbon particulates or activated carbon sorbent 156 can have an MEK adsorption isotherm (at 25° C.) of about 30 wt % to about 50 wt %. More commonly, the MEK adsorption capacity can be between about 30 wt % to about 48 wt %, between about 31 wt % to about 47 wt %, between about 32 wt % to about 46 wt %, between about 33 wt % to about 45 wt %, between about 34 wt % to about 44 wt %, or between about 35 wt % to about 43 wt %.

Spherical granular activated carbon particulates or activated carbon sorbent 156 can have a toluene adsorption isotherm (at 25° C.) of about 80 wt % to about 99 wt %. More commonly, the toluene adsorption capacity can be at least about 80 wt %, at least about 81 wt %, at least about 82 wt %, at least about 83 wt %, at least about 84 wt %, at least about 85 wt %, at least about 86 wt %, at least about 87 wt %, at least about 88 wt %, at least about 89 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, or at least about 99 wt %.

Spherical granular activated carbon particulates or activated carbon sorbent 156 can have a limonene adsorption isotherm (at 25° C.) of about 20 wt % to about 50 wt %. More commonly, the limonene adsorption capacity can be between about 21 wt % to about 49 wt %, between about 22 wt % to about 48 wt %, between about 23 wt % to about 47 wt %, between about 24 wt % to about 46 wt %, between about 25 wt % to about 45 wt %, between about 26 wt % to about 44 wt %, between about 27 wt % to about 43 wt %, between about 28 wt % to about 42 wt %, between about 29 wt % to about 41 wt %, between about 29 wt % to about 40 wt %, between about 29 wt % to about 39 wt %, or between about 29 wt % to about 38 wt %. More commonly, the limonene adsorption capacity can be at least about 25 wt %, at least about 26 wt %, at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, or at least about 50 wt %.

The spherical granular activated carbon sorbent particulates 156 or activated carbon sorbent can have an apparent density (in grams per cubic centimeter) of between about 0.30 g/cc to about 0.60 g/cc. More commonly, the apparent density can be between 0.30 g/cc to about 0.55 g/cc, between about 0.35 g/cc to about 0.50 g/cc, or between about 0.36 g/cc to about 0.43 g/cc. In embodiments, the apparent density can be at least about 0.30 g/cc, at least about 0.31 g/cc, at least about 0.32 g/cc, at least about 0.33 g/cc, at least about 0.34 g/cc, at least about 0.35 g/cc, at least about 0.36 g/cc, at least about 0.37 g/cc, at least about 0.38 g/cc, at least about 0.39 g/cc, at least about 0.40 g/cc, at least about 0.41 g/cc, at least about 0.42 g/cc, at least about 0.43 g/cc, at least about 0.44 g/cc, at least about 0.45 g/cc, at least about 0.46 g/cc, at least about 0.47 g/cc, at least about 0.48 g/cc, at least about 0.49 g/cc, or at least about 0.50 g/cc. In embodiments, additionally or alternatively, the apparent density can be commonly no more than about 0.60 g/cc, commonly no more than about 0.59 g/cc, commonly no more than about 0.58 g/cc, commonly no more than about 0.57 g/cc, commonly no more than about 0.56 g/cc, commonly no more than about 0.55 g/cc, commonly no more than about 0.54 g/cc, commonly no more than about 0.53 g/cc, commonly no more than about 0.52 g/cc, commonly no more than about 0.51 g/cc, or commonly no more than about 0.50 g/cc.

As can be seen from FIG. 1, the process is free of pre-oxidation before the thermally setting and thermally charring stage.

### EXPERIMENTAL

The following examples are provided to illustrate certain embodiments of the disclosure and are not to be construed as limitations on the disclosure, as set forth in the appended claims. All parts and percentages are by weight unless otherwise specified.

The uniqueness of making activated carbon from different raw materials, specifically reclaimed bituminous fines through multiple washing, drying and grinding steps is investigated. One step is to carefully control the thermoplastic/free swelling properties of bituminous coal to enhance the development of pore structure and create microstructure in the coal particles to enhance the contaminant transport and sequestration into the carbon pores while reducing non-adsorption contributing interparticle void space within the granules. The ability to form a thermoplastic/free swelling material can allow for the primary coal particles to coalesce to a certain degree and reduce interparticle void space while forming the desired intraparticle pore structure. Whereas prior art uses a pre-charring oxidization coal step to minimize coking, the method of this disclosure does not employ pre-oxidation and instead takes advantage of well-controlled coking/plasticization/charring of the fine purified coal particle to create unique intra-particle and intra-granule structure/chemistry properties. Granules with high uniformity and high aspect ratio (width to length) are formed through assembling and densifying of coal particles with a green strength binder and the activation binder in the pin mixer. The unique resultant spherical shape creates benefits in use, such as reducing the particle abrasion and operating pressure drop in the column and vessel applications. The tuned surface structure and carbon property of the finished activated granules provide enhanced and efficient contaminant removal.

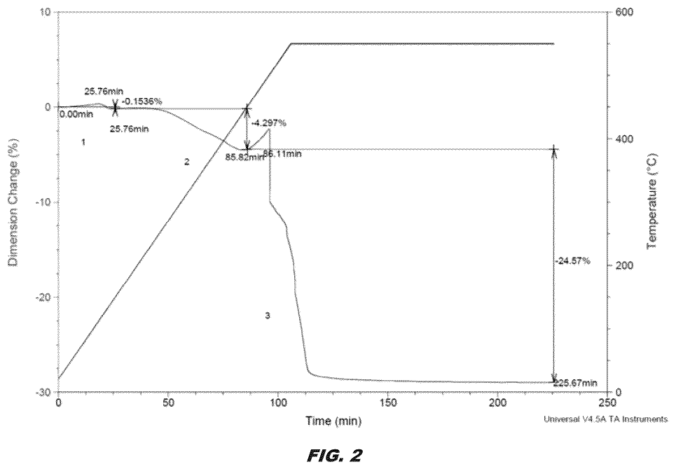

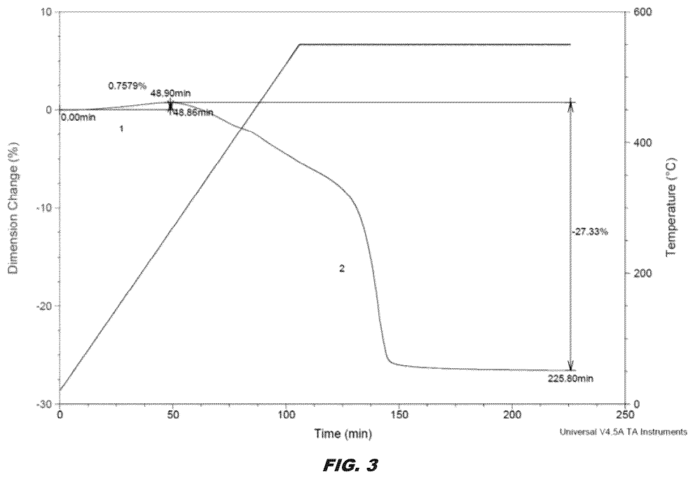

As shown in FIG. 2, the purified coal feed material (before shaping and pin mixing) shows an expansion of about 2.5% at temperature of 400-450° C. under nitrogen. As shown in FIG. 3 (post shaping), a pin mixed 2×6 granule (before charring and activation) shows reduced expansion to 0.76% at temperature˜265 C under nitrogen, indicating better control of the coking step and resultant plastic properties of bituminous coal. The careful control of plasticization/liquefaction/coking of the purified coal feed material can be important to creating the GAC porosity infrastructure and structural hardness for high contaminant removal performance.

Table 1 below shows the properties of spherical granular activated carbon particulates manufactured using the process of the present disclosure.

TABLE 1

| | Industry Standard | Novel |
|---|---|---|
| | 12 × 40 | 12 × 40 |
| GAC | Bituminous GAC | Bituminous GAC |
| Sphericity | 0.85 | 0.95 |
| Aspect Ratio (e.g., | 0.7 | 0.8 |
| width/length-closer to | | |
| 1.0 equates to more | | |
| sphericity) | | |
| Dustiness (wt %) | 0.2% | 0.1% |
| Ball Pan Hardness (%) | 95 | 95 |
| Abrasion Number (%) | 87 | 85 |
| Iodine Number (mg/g) | 1000 | 1000 |
| Micropore volume | 0.33 | 0.38 |
| (cc/g) | | |
| Mesopore volume (cc/g) | 0.21 | 0.25 |
| Particle Density (g/cc) | 0.97 | 0.95 |

A series of experiments were performed to evaluate theoretical pressure drop from the improved sphericity of the spherical granular activated carbon particulates of the present disclosure. The Kozeny-Carman equation which models pressure drop during laminar fluid flow through a packed column is used to approximate the impact of sphericity and on pressure drop.

$$\begin{matrix}\frac{Δ P}{L} = \frac{180 μ}{{φ}^{2} {D}_{p}^{2}} \frac{{( 1 - ε )}^{2}}{{ε}^{3}} {μ}_{s} \\ \frac{Δ P}{L} = pressure drop \\ μ = fluid viscosity \\ φ = sphericity \\ ε = void volume \\ {D}_{P} = particle diameter \\ {μ}_{s} = superficial velocity\end{matrix}$$

An increase in sphericity from 0.85 to 0.95 can be anticipated to decrease pressure drop by approximately 20%. Alternatively, a more spherical particle can be used to achieve the same pressure drop with a smaller particle thereby improving adsorption kinetics and potential adsorption capacity through increased accessible pore volume and external surface area. For example, when sphericity is increased from 0.85 to 0.95, a particle size can be decreased by about 11% while maintaining the same pressure drop.

In a further series of experiments, the adsorption capacity of the spherical granular activated carbon particulates for Taste and Odor Molecules and Total Organic Carbon (TOC) was determined. As shown in Table 2 below, the novel bituminous GAC spherical granular activated carbon particulates outperform industry standard bituminous GAC by 7-66% across the board for all constituents in four different water sources. The lower performance factor indicates lower carbon dosage required to achieve the targeted removal performance.

TABLE 2

| | | Comparative Performance Factors | | |
|---|---|---|---|---|
| | | $( \frac{wt . carbon of interest}{wt . reference carbon} required to reach target conc . )$ | | |
| | | Total Organic | | Geosmin |
| | | Carbon (TOC) | Methylisoborneol | (GSM) |
| | | [20% | (MIB) | [90% |
| Waters | Carbon | removal] | [70% removal] | removal] |
| Synthetic | Industry | 1.00 | 1.00 | 1.00 |
| water | Bituminous | | | |
| | GAC | | | |
| (TOC = 6 ppm) | Novel | 0.73 | 0.66 | 0.51 |
| | Bituminous | | | |
| | GAC | | | |
| City in | Industry | | | |
| Ohio | Bituminous | 1.00 | 1.00 | 1.00 |
| (TOC = | GAC | | | |
| 9.1 ppm) | Novel | 0.47 | 0.56 | 0.48 |
| | Bituminous | | | |
| | GAC | | | |
| City in | Industry | 1.00 | 1.00 | 1.00 |
| Texas | Bituminous | | | |
| (TOC = | GAC | | | |
| 7.5 ppm) | Novel | 0.44 | 0.78 | 0.57 |
| | Bituminous | | | |
| | GAC | | | |
| City in | Industry | 1.00 | 1.00 | 1.00 |
| Illinois | Bituminous | | | |
| (TOC = | GAC | | | |
| 5.6 ppm) | Novel | 0.55 | 0.93 | 0.58 |
| | Bituminous | | | |
| | GAC | | | |

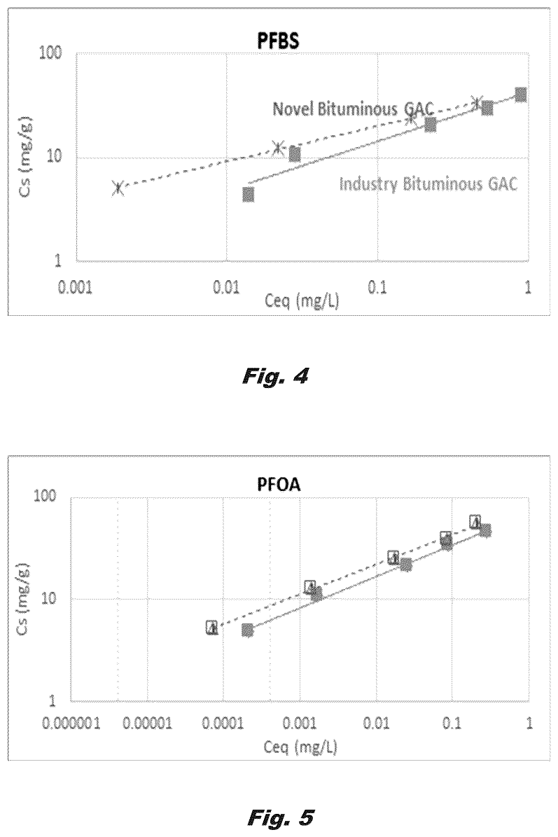

In a series of experiments, the capacity of the spherical granular activated carbon particulates for Per and Polyfluoroalkyl Substances (PFAS) was evaluated. FIGS. 4 and 5 show that the spherical granular activated carbon particulates or “novel” bituminous GAC single-in a solute isotherm in synthetic groundwater outperformed the industry bituminous GAC in adsorbing both PFBS and PFOA.

In a series of experiments, the kinetics of adsorption for the bituminous novel GAC was evaluated. As shown in Table 3, once particle size is controlled, tuning of carbon's surface/pore characteristics can allow for faster adsorption kinetics of the bituminous spherical granular activated carbon particulates for dilute Taste & Odor compounds and greater adsorption capacity for Total Organic Carbon (TOC). Compared to conventional bituminous activated carbon (“Industry”), this result is likely a result of increased sequestration pores in the novel bituminous GAC and/or differences in the carbon microstructure.

TABLE 3
Ratio of Industry/Novel adsorption capacity
at 10 minutes to 24 hours (Higher is Better)

| Constituent | Industry | Novel |
|---|---|---|
| MIB | 0.4 | 0.7 |
| GSM | 0.4 | 0.6 |
| TOC | 0.5 | 0.5 |

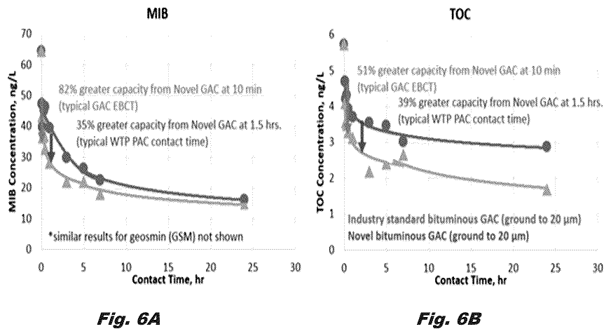

Referring to FIG. 6A, comparing the upper curve corresponding to industry standard bituminous GAC to the lower curve corresponding to the novel GAC of the present disclosure shows that the novel bituminous GAC of the present disclosure has an approximate 82% greater capacity for both 2-methylisoborneol (MIB) and geosmin after 10 minutes of contact (typical GAC empty bed contact time (EBCT) and 35% greater capacity after 1.5 hours of contact (typical water treatment plant (WTP) powdered activated carbon (PAC) contact time.

Referring to FIG. 6B, comparing the upper curve corresponding to industry standard bituminous GAC to the lower curve corresponding to the novel bituminous GAC of the present disclosure shows that the novel bituminous GAC of the present disclosure has an approximate 51% greater capacity for total organic carbon (TOC) after 10 minutes of contact (typical GAC empty bed contact time (EBCT) and 39% greater capacity after 1.5 hours of contact (typical water treatment plant (WTP) powdered activated carbon (PAC) contact time.

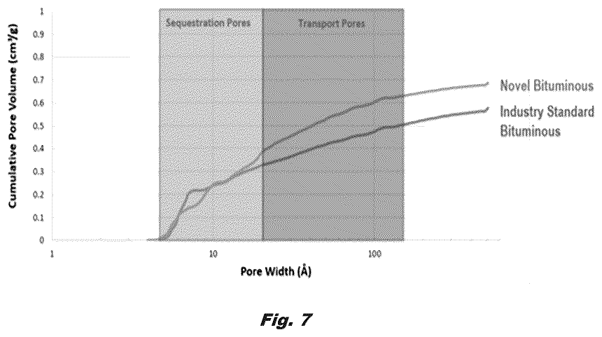

FIG. 7 depicts cumulative pore volume comparison between novel and industry standard bituminous GAC as measured by nitrogen adsorption using Micromeritics 3Flex and modeled by Density Functional Theory. As will be appreciated, sequestration pores have a pore diameter up to 20 Å while transport pores have a pore diameter ranging from about 20 to 150 Å. FIG. 7 shows that the novel bituminous GAC of the present disclosure has a higher cumulative pore volume of sequestration pores and a markedly higher cumulative pore volume of transport pores.

Table 4 compares the characteristics of novel and industry standard bituminous GAC.

TABLE 4

| | | | | small | DFT micro + | |
|---|---|---|---|---|---|---|
| | | Micropore | Mesopore | mesopore | mesopore | |
| | Iodine | volume | volume | volume | volume | TGA wt |
| | Number | 0-20 Å | 20-500 Å | 20-150 Å | <500 Å | loss % |
| Description | mg/g | (cc/g) | (cc/g) | (cc/g) | (cc/g) | (400-750 C.) |
| Novel Bituminous | 1009 | 0.39 | 0.30 | 0.23 | 0.69 | 0.19 |
| GAC | | | | | | |
| Industry Bituminous | 980 | 0.33 | 0.25 | 0.17 | 0.57 | 0.38 |
| GAC | | | | | | |

As can be seen from Table 4, novel bituminous GAC has a higher iodine number, higher micropore volume, higher mesopore volume, higher small mesopore volume, higher density functional theory (DFT)+mesopore volume and lower thermogravimetric analysis (TGA) weight loss compared to industry standard bituminous GAC.

A series of experiments was conducted to determine levels of water-extractable arsenic in novel bituminous GAC produced from purified activated carbon compared to industry standard bituminous GAC. As shown in Table 5, the use of a purified coal as feedstock for preparation the novel bituminous GAC results in a 45-84% reduction in extractable Arsenic. Also included was a sample of Novel Bituminous GAC with the addition magnesium oxide which resulted in non-detect levels of leachable arsenic. As will be appreciated, lower Arsenic in the water concentration is required for drinking water applications.

TABLE 5

| | Arsenic water concentration after |
|---|---|
| | 20 wt % GAC is exposed to DI water for |
| | 72 hours filtered to 0.45 um and |
| Carbon | analyzed by ICP |
| Industry Bituminous GAC 1 | 84 |
| Industry Bituminous GAC 2 | 97 |
| Novel Bituminous GAC 1 | 46 |
| Novel Bituminous GAC 2 | 15 |
| Novel Bituminous GAC 1 + | <1 |
| 0.5% MgO | |

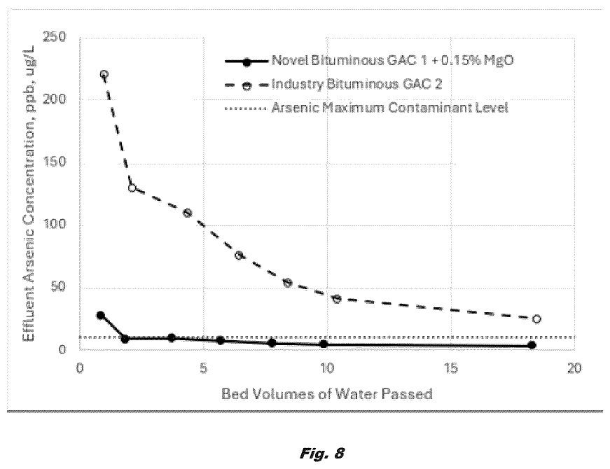

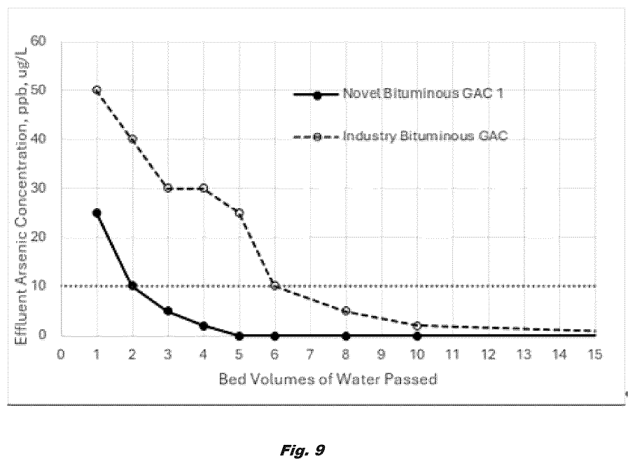

To simulate startup at a drinking water treatment facility, GAC was loaded into a 2.5 cm×15 cm column, filled with tap water and allowed to soak for 24 hours. After 24 hours, tap water was pumped through the column at an empty bed contact time of 10 minutes. Effluent water samples were collected and analyzed for arsenic with either a Hach arsenic test kit (FIG. 8) or by ICP (FIG. 9). FIG. 8 shows that the Novel Bituminous GAC made using purified coal product as its feedstock resulted in a 3× reduction in the bed volumes required to achieve effluent arsenic concentrations of less than the 10 μg/L Maximum Contaminant Level. FIG. 9 shows Novel Bituminous GAC made using purified coal product amended with magnesium oxide as its feedstock achieved effluent arsenic concentrations below the 10 μg/L Maximum Contaminant Level in 2 bed volumes whereas the industry bituminous GAC was still above 10 μg/L after 19 bed volumes.

Finally, a series of experiments were performed to compare the acid gas capacity of the novel modified bituminous GAC compared to industry standard lignite and bituminous GAC. As can be seen in Table 6 below, both novel GAC formulations have a higher H₂S capacity and loading compared to the industry standard lignite and bituminous GAC with comparable BPH to the industry standard bituminous GAC.

TABLE 6

| | Apparent | H₂S | H₂S | Ball Pan |
|---|---|---|---|---|
| | Density | Capacity | Loading | Hardness, |
| GAC 4 × 10 Mesh | g/cc | g/cc | wt % | % |
| Industry Lignite GAC | 0.40 | 0.20 | 50 | 58 |
| Industry Bituminous GAC | 0.54 | 0.01 | 1.5 | 95 |
| Novel Bituminous GAC 3 | 0.41 | 0.23 | 56 | 91 |
| Novel Bituminous GAC 4 | 0.39 | 0.30 | 78 | 96 |

A series of experiments were performed to determine butane activity, carbon tetrachloride capacity, BET surface area, total pore volume, micropore volume, and mesopore volume for various granular activated carbons produced by methods of the present disclosure. The results are presented in Table 7.

TABLE 7
Carbon porosity and butane activity

| | Butane | | | Total | | Mesopore |
|---|---|---|---|---|---|---|
| | Activity | Carbon | BET | Pore | Micropore | Volume, |
| | wt %, | tetra- | Surface | Volume, | Volume, | cc/g |
| | ASTM | chloride | Area, | cc/g | cc/g | (20- |
| GAC | D5742 | wt % | m2/g | (<500 A) | (<20 A) | 500 A) |
| Arq | 23 | 58 | 1078 | 0.62 | 0.39 | 0.23 |
| AirLoq | | | | | | |
| 410 H2S | | | | | | |
| Arq | 24 | 61 | 1040 | 0.64 | 0.37 | 0.26 |
| CarbPure | | | | | | |
| GAC | | | | | | |
| 1240 | | | | | | |
| Arq | 25.5 | 65 | 1121 | 0.65 | 0.41 | 0.24 |
| AirLoq | | | | | | |
| 410 VOC | | | | | | |
| 1 | | | | | | |
| Arq | 28 | 71 | 1100 | 0.75 | 0.39 | 0.36 |
| AirLoq | | | | | | |
| 410 VOC | | | | | | |
| 2 | | | | | | |

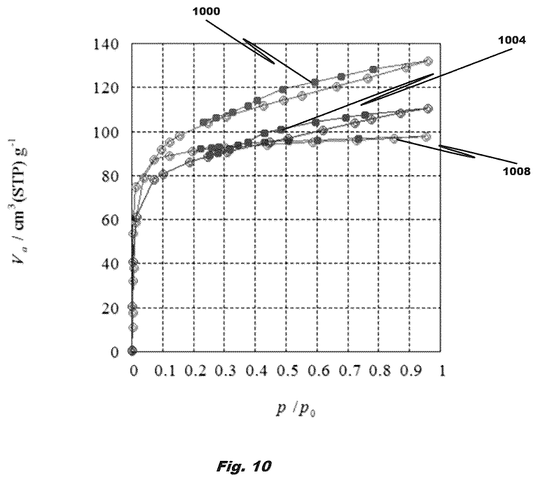

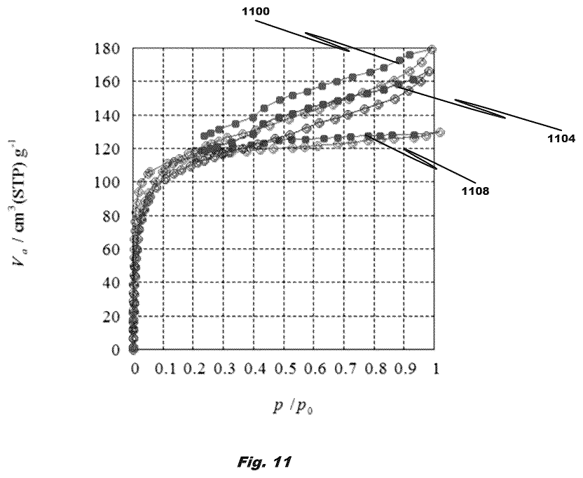

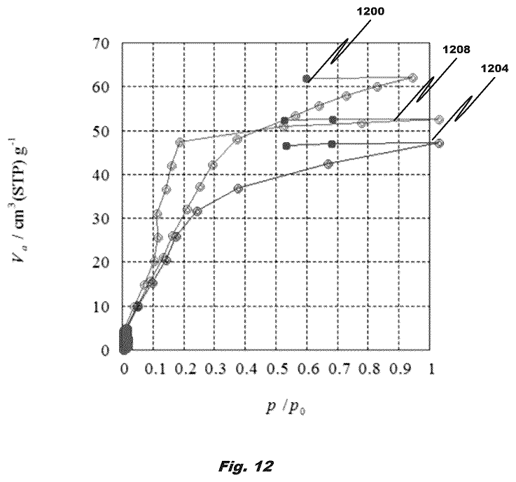

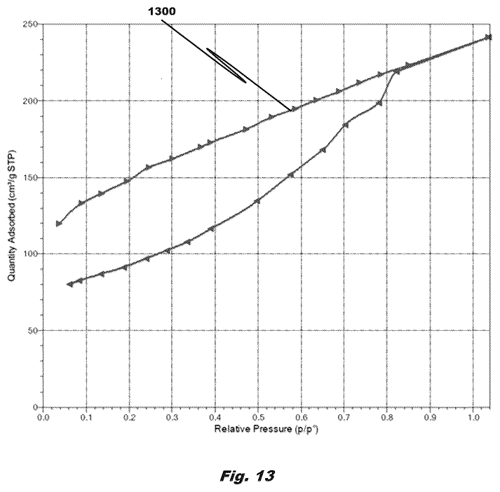

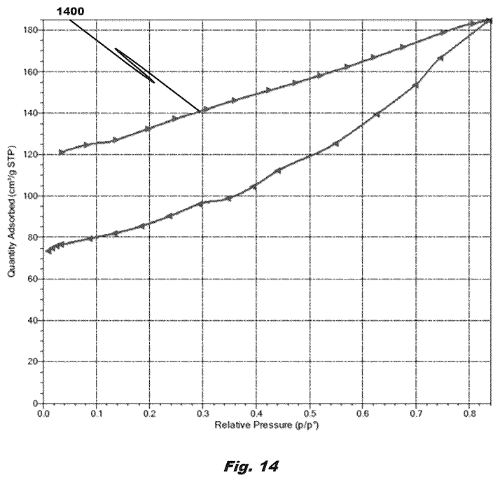

FIGS. 10 through 13 show the comparison of AirLoq VOC products (VOC 1, VOC 2, and VOC 3) and AirLog410 H2S products (H2S 1, H2S 2, H2S 3, and H2S 4) with a coconut based 4×8 GAC regarding butane adsorption, representative VOC adsorption, H₂S adsorption, and associated carbon properties. More specifically, in FIG. 10 plot 1000 represents AirLog410 VOC1, plot 1004 represents AirLog410 H2S 1, and plot 1008 represents 4×8 GAC (made from coconut); in FIG. 11 plot 1100 represents AirLog410 VOC1, plot 1104 represents AirLog410 H2S 1, and plot 1108 represents 4×8 GAC (made from coconut); in FIG. 12 plot 1200 represents AirLog410 VOC1, plot 1204 represents AirLog410 H2S 1, and plot 1208 represents 4×8 GAC (made from coconut); in FIG. 13 plot 1300 represents the full isotherm of toluene adsorption at 25° C. for AirLoq 410 VOC1; and in FIG. 14 plot 1400 represents the full isotherm of toluene adsorption at 25° C. for 4×8 GAC (made from coconut).

FIGS. 10 through 12 show the volumetrically determined load as a function of the relative pressure.

AirLoq 410 VOC 1 outperformed coconut-based GAC by at least 10% for acetone, MEK, Toluene and Limonene adsorption, as shown in table 8 below.

TABLE 8
Comparison of carbon adsorption for butane, and representative VOCs

| | | | Butane | | | | | | | |
|---|---|---|---|---|---|---|---|---|---|---|
| | Butane | (Carbon | Working | | | | | | | |
| | Activity | Tetra- | Capacity | | | | | | | |
| Carbon for | wt %, | chloride) | wt. %, | Adsorption Isotherm at 25 C. | | | | Apparent | H2S | H2S |
| VOC & | ASTM | CTC | ASTM | Acetone, | MEK, | Toluene, | Limonene, | Density, | Capacity, | Loading, |
| Siloxanes | D5742 | wt % | D5228 | wt % | wt % | wt % | wt % | g/cc | g/cc | wt % |
| 4 × 8 GAC | 23.3 | 59.4 | 1.3 | 34 | 32 | 71 | 32 | 0.49 | 0.03 | 7% |
| (Coconut) | | | | | | | | | | |
| AirLoq410 | 23.1 | 58.9 | 7.0 | 46 | 43 | 92 | 38 | | | |
| VOC 1 | | | | | | | | | | |
| AirLoq410 | 27.6 | 70.4 | 11.6 | | | | | | | |
| VOC 2 | | | | | | | | | | |
| AirLoq410 | 29.1 | 74.2 | 15.0 | | | | | | | |
| VOC 3 | | | | | | | | | | |
| AirLoq410 | 22.8 | 58.1 | 8.6 | 43 | 35 | | 29 | 0.41 | 0.23 | 56% |
| H2S 1 | | | | | | | | | | |
| AirLoq410 | 24.1 | 61.5 | 11.2 | | | | | 0.43 | 0.32 | 75% |
| H2S 2 | | | | | | | | | | |
| AirLoq410 | 26.5 | 67.6 | 13.1 | | | | | 0.36 | 0.36 | 100% |
| H2S 3 | | | | | | | | | | |
| AirLoq410 | 28.1 | 71.7 | 15.2 | | | | | 0.36 | 0.38 | 105% |
| H2S 4 | | | | | | | | | | |

AirLoq 410 VOC 3 and AirLoq410 H2S 4 achieved over 70 wt % CTC, and 15 wt % butane working capacity. AirLoq410 H2S GACs also demonstrated high H2S adsorption capacity over 0.3 g/cc, due to higher pore volume in both micropore (for VOC adsorption) and mesopore (for H₂S adsorption) range, as shown in Table 9 below.

TABLE 9
Carbon properties

| | | | Total | | |
|---|---|---|---|---|---|
| | Iodine | BET | Pore | Micro | Meso |
| Carbon for VOC & | Number, | Area | Volume | Pores | Pores |
| Siloxanes | mg/g | m2/g | cc/g | cc/g | cc/g |
| 4 × 8 GAC (Coconut) | 1133 | 1244 | 0.55 | 0.49 | 0.06 |
| AirLoq410 VOC 1 | | 984 | 0.54 | 0.37 | 0.17 |
| AirLoq410 VOC 2 | 1023 | 1126 | 0.67 | 0.41 | 0.27 |
| AirLoq410 VOC 3 | | 1155 | 0.67 | 0.42 | 0.25 |
| AirLoq410 H2S 1 | 1064 | 1078 | 0.62 | 0.39 | 0.23 |
| AirLoq410 H2S 2 | 932 | 959 | 0.60 | 0.35 | 0.25 |
| AirLoq410 H2S 3 | 982 | 1048 | 0.73 | 0.37 | 0.36 |
| AirLoq410 H2S 4 | 1008 | 1170 | 0.88 | 0.38 | 0.50 |

AirLoq410 products with uniformly spherical shape offering lower pressure drop and comprising a tailored pore structure and optimized surface oxidation chemistry, exhibit enhanced performance in hydrogen sulfide (H₂S) removal while simultaneously providing maximized adsorption capacities in a broad spectrum of volatile organic compounds (VOCs). This dual-function capability surpasses the performance of industrial standard lignite-based granular activated carbon in H₂S removal and coconut-based GAC in VOC adsorption. Since the oxidation catalyst is incorporated before the activation, unlike the post-spray or the impregnated carbon media, AirLoq 410 will not cause bricking, potential bed heat up, or spontaneous combustion. All AirLoq 410's pore volume and surface area are available for storing sulfur converted from the H₂S adsorbed and for the adsorption of any additional volatile organic compounds that may exist in the gas stream.

The exemplary systems and methods of this disclosure have been described in relation to carbonaceous materials. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A sorbent composition comprising primarily activated carbon, at least most of the particulates of the sorbent composition having a mean and/or median sphericity in the range of from about 0.75 to about 1.0, a total pore volume ranging from about 0.5 to about 0.95 cc/g, a pore volume for pores less than 500 Å ranging from about 0.6 to about 0.8 cc/g, and a BET surface area of at least about 900 m²/g, and having at least one of a butane activity (measured by ASTM Method D5742) of more than about 20 wt % and a butane working capacity (measured by ASTM Method D5228) of at least about 5 wt %.

2. The sorbent composition of claim 1, further comprising one or more super oxidants.

3. The sorbent composition of claim 1, wherein the butane activity is greater than about 20 wt %, wherein the sorbent composition comprises at least about 75 wt % carbon, wherein the sorbent composition has a ball ban hardness of greater than about 60%, a BET surface area of at least about 900 m²/g, a total pore volume in the range of from about 0.55 to about 0.90 cc/g, and a total pore volume for pores less than 500 Å ranging from about 0.62 to about 0.78 cc/g.

4. The sorbent composition of claim 3, wherein a total pore volume of pores in the range of more than 20 to about 500 Å ranges from about 0.2 to about 0.4 cc/g and a total volume of pores equal to or less than 20 Å ranges from about 0.3 to about 0.5 cc/g.

5. The sorbent composition of claim 1, wherein at least about 60% of the sorbent composition particulates have a sphericity ranging from about 0.85 to about 1 and an aspect ratio of at least about 0.7 and wherein the sorbent composition has an iodine number ranging from about 900 mg/g to about 1150 mg/g and an apparent density ranging from about 0.3 to about 0.6 g/cc.

6. The sorbent composition of claim 1, wherein the sorbent composition has a carbon tetrachloride capacity is at least about 50 wt %, an H₂S capacity of at least about 0.2 g/cc, and an H₂S loading of at least about 50 wt %.

7. The sorbent composition of claim 1, wherein the sorbent composition has an acetone adsorption isotherm percentage (at 25° C.) ranging from about 40 wt % to about 50 wt %, an MEK adsorption isotherm percentage (at 25° C.) ranging from about 30 wt % to about 50 wt %, a toluene adsorption isotherm percentage (at 25° C.) of at least about 80 wt %, and a limonene adsorption capacity (at 25° C.) ranging from about 20 wt % to about 50 wt %.

8. A sorbent composition comprising primarily activated carbon, at least most of the particulates of the sorbent composition having a mean and/or median sphericity in the range of from about 0.75 to about 1.0, a total pore volume ranging from about 0.5 to about 0.95 cc/g, a pore volume for pores less than 500 Å ranging from about 0.6 to about 0.8 cc/g, and a BET surface area of at least about 900 m²/g, and having at least one of a carbon tetrachloride capacity of at least about 50 wt %, an H₂S capacity of at least about 0.2 g/cc, and an H₂S loading of at least about 50 wt %.

9. The sorbent composition of claim 8, further comprising one or more super oxidants.

10. The sorbent composition of claim 8, wherein the sorbent composition has a carbon tetrachloride capacity of at least about 50 wt %, an H₂S capacity of at least about 0.2 g/cc, and an H₂S loading of at least about 50 wt %, wherein the sorbent composition comprises at least about 75 wt % carbon, wherein the sorbent composition has a ball ban hardness of greater than about 60%, a BET surface area of at least about 900 m²/g, a total pore volume in the range of from about 0.55 to about 0.90 cc/g, and a total pore volume for pores less than 500 Å ranging from about 0.62 to about 0.78 cc/g.

11. The sorbent composition of claim 10, wherein a total pore volume of pores in the range of more than 20 to about 500 Å ranges from about 0.2 to about 0.4 cc/g and a total volume of pores equal to or less than 20 Å ranges from about 0.3 to about 0.5 cc/g.

12. The sorbent composition of claim 8, wherein at least about 60% of the sorbent composition particulates have a sphericity ranging from about 0.85 to about 1 and an aspect ratio of at least about 0.7 and wherein the sorbent composition has an iodine number ranging from about 900 mg/g to about 1150 mg/g and an apparent density ranging from about 0.3 to about 0.6 g/cc.

13. The sorbent composition of claim 8, wherein the sorbent composition has a butane activity (measured by ASTM Method D5742) of more than about 20 wt % and a butane working capacity (measured by ASTM Method D5228) of at least about 5 wt %.

14. The sorbent composition of claim 8, wherein the sorbent composition has an acetone adsorption isotherm percentage (at 25° C.) ranging from about 40 wt % to about 50 wt %, an MEK adsorption isotherm percentage (at 25° C.) ranging from about 30 wt % to about 50 wt %, a toluene adsorption isotherm percentage (at 25° C.) of at least about 80 wt %, and a limonene adsorption capacity (at 25° C.) ranging from about 20 wt % to about 50 wt %.

15. A method, comprising:
providing a carbonaceous feed material comprising at least about 50 wt % carbon, no more than about 10 wt % ash, and a free swelling index of more than about 1 and having a D₅₀ size distribution of no more than about 100 microns;
contacting the carbonaceous feed material with at least about 0.1 wt % of a green strength binder and optionally at least about 0.1 wt % of an activation binder to form a feed mixture;
homogenizing the feed mixture in a homogenizer to an homogenized feed mixture having a D₅₀ particle size of no more than about 100 μm;
shaping the homogenized feed mixture in a spheronizer to form spheronized agglomerates, at least most of the spheronized agglomerates having a sphericity ratio ranging from about 0.75 to about 1.0 and an aspect ratio of at least about 0.7;
charring, at a charring temperature of no more than about 1,200° F., the spheronized agglomerates in a charring kiln to form charred agglomerates; and
activating the charred agglomerates, in the presence of steam and at an activation temperature ranging from about 1,400 to about 2,000° F., to form spherical granular activated carbon particulates, wherein the spherical activated carbon particulates have at least one of a butane activity (measured by ASTM Method D5742) of more than about 20 wt % and a butane working capacity (measured by ASTM Method D5228) of at least about 5 wt %.

16. The method of claim 15, further comprising contacting the carbonaceous feed material with at least about 0.1 wt % of an activation binder and at least about 0.1 wt % one or more super oxidants to form the feed mixture.

17. The method of claim 15, wherein the butane activity ranges from about 25%, wherein the spherical activated carbon particulates comprise at least about 75 wt % carbon, wherein the spherical activated carbon particulates have a ball ban hardness of greater than about 60%, a BET surface area of at least about 900 m²/g, a total pore volume in the range of from about 0.55 to about 0.90 cc/g, and a total pore volume for pores less than 500 Å ranging from about 0.62 to about 0.78 cc/g.

18. The method of claim 17, wherein a total pore volume of pores in the range of more than 20 to about 500 Å ranges from about 0.2 to about 0.4 cc/g and a total volume of pores equal to or less than 20 Å ranges from about 0.3 to about 0.5 cc/g.

19. The method of claim 15, wherein at least about 60% of the spherical activated carbon particulates have a sphericity ranging from about 0.85 to about 1 and an aspect ratio of at least about 0.7 and wherein the spherical activated carbon particulates have an iodine number ranging from about 900 mg/g to about 1150 mg/g and an apparent density ranging from about 0.3 to about 0.6 g/cc.

20. The method of claim 15, wherein the spherical activated carbon particulates have a carbon tetrachloride capacity is at least about 50 wt %, an H₂S capacity of at least about 0.2 g/cc, and an H₂S loading of at least about 50 wt %.

21. The method of claim 15, wherein the spherical activated carbon particulates have an acetone adsorption isotherm percentage (at 25° C.) ranging from about 40 wt % to about 50 wt %, an MEK adsorption isotherm percentage (at 25° C.) ranging from about 30 wt % to about 50 wt %, a toluene adsorption isotherm percentage (at 25° C.) of at least about 80 wt %, and a limonene adsorption capacity (at 25° C.) ranging from about 20 wt to about 50 wt %.
